(19) United States
(12) Patent Application Publication
(10) Pub. No.: US 2024/0290151 A1
(43) Pub. Date: Aug. 29, 2024

(54) INFORMATION PROCESSING DEVICE, INFORMATION PROCESSING METHOD, AND PROGRAM

(71) Applicant: SONY GROUP CORPORATION, TOKYO (JP)

(72) Inventors: SAKURA YAMAKI, TOKYO (JP); YUKI TANAKA, TOKYO (JP); DAIKI KUWABARA, TOKYO (JP)

(21) Appl. No.: 18/566,250

(22) PCT Filed: Feb. 15, 2022
(86) PCT No.: PCT/JP2022/005796

§ 371 Date: Dec. 1, 2023

(30) Foreign Application Priority Data
Jun. 11, 2021 (JP) 2021-097810

(51) Int. Cl. G07C 9/00; B62H 5/00; G07C 9/28

(52) U.S. Cl. CPC G07C 9/00309; B62H 5/00; G07C 9/00571; G07C 9/28; G07C 2009/00634; G07C 2209/64

(57) ABSTRACT

The present disclosure relates to an information processing device, an information processing method, and a program capable of implementing a system for grasping that a moving article exists in a specific area at low cost. A proximity determination unit determines a proximity state between a battery-less non-mobile device and a battery-less mobile device by using determination information generated on the basis of a first proximity operation with the non-mobile device and a second proximity operation with the mobile device. The technology according to the present disclosure can be applied to, for example, a share cycle system.

### TECHNICAL FIELD

The present disclosure relates to an information processing device, an information processing method, and a program, and more particularly relates to an information processing device, an information processing method, and a program capable of implementing a system for grasping that a moving article exists in a specific area at low cost.

### BACKGROUND ART

A system for grasping that a specific article is present at a position specified in advance is known.

Patent Document 1 discloses an authentication system capable of confirming whether or not a transport container is correctly transported to a transport destination by authenticating, by an authentication server, a transport container that has acquired position information transmitted from a position information transmission device installed at a fixed place.

### CITATION LIST

### Patent Document

Patent Document 1: Japanese Patent Application Laid-Open No. 2016-81208

### SUMMARY OF THE INVENTION

### Problems to be Solved by the Invention

However, in order to implement the system as disclosed in Patent Document 1, it is necessary that the position information transmission device includes a battery for transmitting position information or the transport container includes a battery for communication and authentication with the authentication server. Installation and replacement of such a battery require a lot of costs, and is a burden for a business operator who provides a service using the system.

The present disclosure has been made in view of such a situation, and an object thereof is to implement a system for grasping that a moving article exists in a specific area at low cost.

### Solutions to Problems

An information processing device of the present disclosure is an information processing device including a proximity determination unit that determines a proximity state between a battery-less non-mobile device and a battery-less mobile device by using determination information generated on the basis of a first proximity operation with the non-mobile device and a second proximity operation with the mobile device.

An information processing method of the present disclosure is an information processing method including, by an information processing device, determining a proximity state between a battery-less non-mobile device and a battery-less mobile device by using determination information generated on the basis of a first proximity operation with the non-mobile device and a second proximity operation with the mobile device.

A program of the present disclosure is a program for causing a computer to execute processing of determining a proximity state between a battery-less non-mobile device and a battery-less mobile device by using determination information generated on the basis of a first proximity operation with the non-mobile device and a second proximity operation with the mobile device.

In the present disclosure, a proximity state between a battery-less non-mobile device and a battery-less mobile device is determined by using determination information generated on the basis of a first proximity operation with the non-mobile device and a second proximity operation with the mobile device.

### BRIEF DESCRIPTION OF DRAWINGS

FIG. 1 is a diagram illustrating an example of a share cycle system.

FIG. 2 is a diagram illustrating an outline of an authentication system to which the technology according to the present disclosure is applied.

FIG. 3 is a block diagram illustrating a functional configuration example of the authentication system.

FIG. 4 is a diagram illustrating an example of a port DB and a bicycle DB.

FIG. 5 is a diagram illustrating an overall flow of an operation of the authentication system.

FIG. 6 is a diagram illustrating an overall flow of an operation of the authentication system.

FIG. 7 is a flowchart for describing an operation of a terminal device.

FIG. 8 is a flowchart for describing an operation of the terminal device.

FIG. 9 is a diagram illustrating an example of a display screen of the terminal device.

FIG. 10 is a diagram illustrating a specific example of proximity determination processing.

FIG. 11 is a diagram illustrating a specific example of proximity determination processing.

FIG. 12 is a diagram illustrating a specific example of proximity determination processing.

FIG. 13 is a diagram illustrating a specific example of proximity determination processing.

FIG. 14 is a flowchart illustrating details of authentication processing of a non-mobile device.

FIG. 15 is a flowchart illustrating details of authentication processing of a mobile device.

FIG. 16 is a diagram for describing rewriting of the port DB and the bicycle DB.

FIG. 17 is a diagram illustrating another functional configuration example of the authentication system.

FIG. 18 is a block diagram illustrating a configuration example of a computer.

### MODE FOR CARRYING OUT THE INVENTION

Hereinafter, modes for carrying out the present disclosure (hereinafter referred to as embodiments) will be described. Note that the description will be made in the following order.
1. Background and technical problem
2. Authentication system to which technology according to present disclosure is applied
3. Operation of authentication system
4. Operation of terminal device and UI
5. Specific example of proximity determination processing
6. Details of authentication processing of non-mobile device and mobile device
7. Modification examples and other application examples
8. Configuration example of computer

### <1. Background and Technical Problems>

Conventionally, provision of mobility services including Mobility as a Service (MaaS) is spreading. In the mobility service, a mobility such as an automobile, a bicycle, a personal mobility vehicle, or the like is lent/returned at a lending/returning base called a port. In a system that implements such a service, a means for confirming that the mobility is lent/returned at a port is required in order to prevent occurrence of disorderly parking, unauthorized leaving, and theft.

In a current mobility lending/returning system, a mobility acquires position information transmitted from a port, and an authentication server performs mutual authentication with the mobility by using the location information and determines that the mobility exists in a correct port, thereby performing the lending/returning.

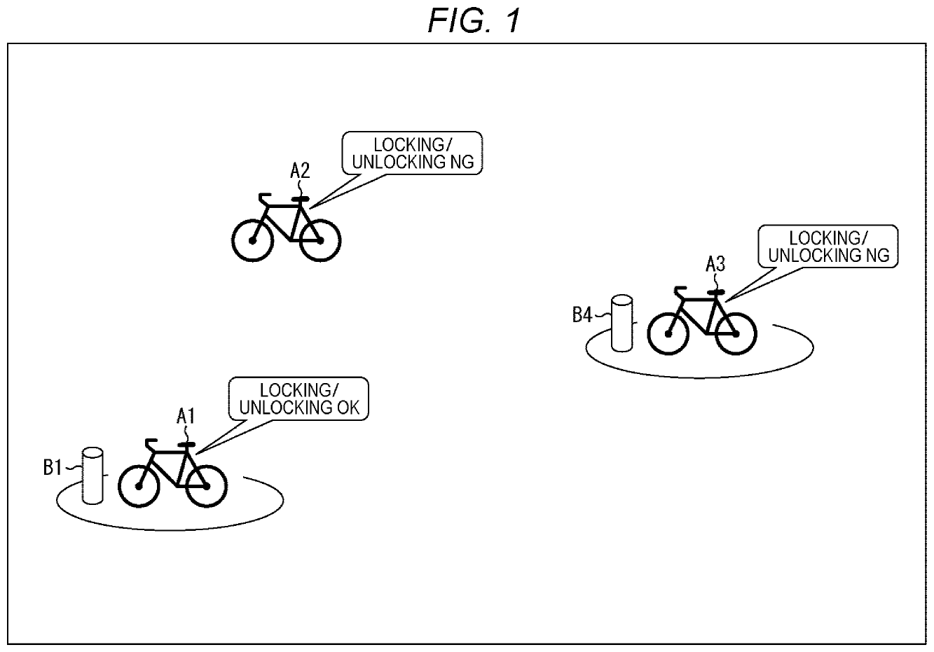

FIG. 1 is a diagram illustrating an example of a share cycle system as an example of a mobility lending/returning system.

In the share cycle system of FIG. 1, in a case where bicycles A1, A2, and A3 are present at the correct ports, the electronic lock of each bicycle can be locked/unlocked, and lending/returning is performed.

Since the bicycle A1 exists in a correct port B1, the electronic lock can be locked/unlocked, and the bicycle A1 is in a state of being able to be rented/returned.

On the other hand, since the bicycle A2 is present in a place where there is no port, locking/unlocking of the electronic lock becomes impossible, and the bicycle A2 is in a state of being unable to be rented/returned. Furthermore, since the bicycle A3 exists in a wrong (where it should not originally exist) port B4, locking/unlocking of the electronic lock becomes impossible, and the bicycle A3 is in a state of being unable to be rented/returned.

In the share cycle system of FIG. 1, the bicycle and the authentication server (not illustrated) perform authentication using the position information of the port, to thereby determine whether or not the bicycle exists in the correct port.

However, in order to implement the share cycle system of FIG. 1, it is necessary that the port includes a battery for transmitting the position information or the bicycle is equipped with a battery for communication and authentication with the authentication server. Installation and replacement of such a battery require a lot of costs, and is a burden for a business operator who provides a service using the system.

Accordingly, in the following, a configuration for implementing a system for grasping that a moving article exists in a specific area at low cost will be described.

<2. Authentication System to which Technology According to Present Disclosure is Applied>

### (Outline of Authentication System)

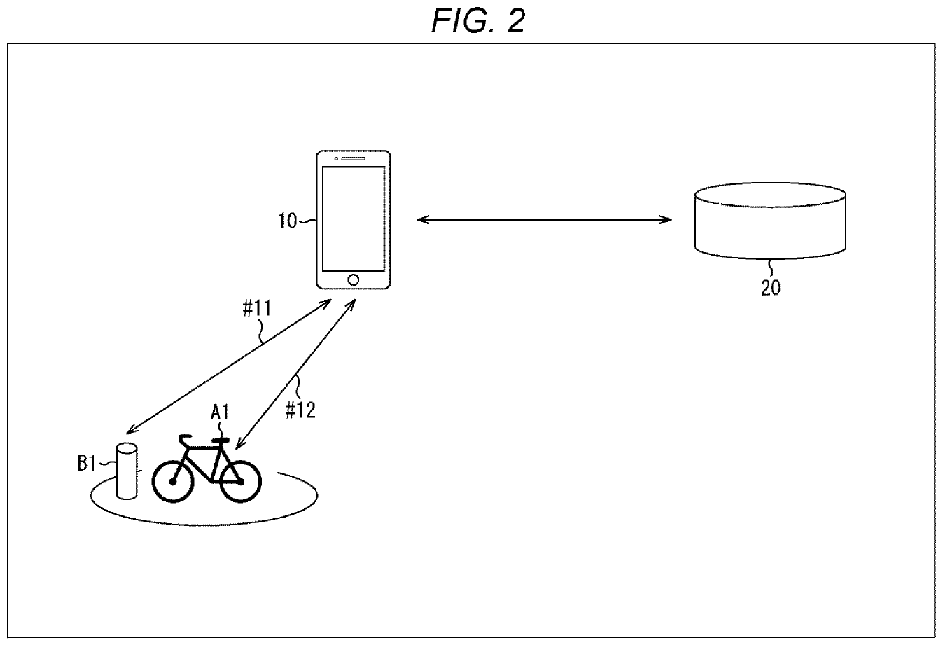

FIG. 2 is a diagram illustrating an outline of an authentication system to which the technology according to the present disclosure is applied. Here, it is assumed that the authentication system of FIG. 2 is applied to the share cycle system illustrated in FIG. 1.

The authentication system of FIG. 2 includes the bicycle A1 and the port B1 illustrated in FIG. 1, a terminal device 10 owned by a user (not illustrated), and an authentication server 20.

In the authentication system of FIG. 2, the bicycle A1 that is a moving article is equipped with a communication device having no battery for communication/authentication as a movable battery-less mobile device.

Similarly, the port B1 includes a communication device having no battery for transmitting position information as a battery-less non-mobile device fixed at a specific position. The battery herein refers to a battery that generates electric energy by a chemical reaction. That is, the communication device (battery-less mobile device) mounted on the bicycle A1 does not include at least a battery for communication/authentication.

Furthermore, the communication device (battery-less non-mobile device) included in the port B1 does not include at least a battery for transmitting position information. However, the bicycle A1 or the port B1 itself may have a battery for other purposes, and for example, a battery or a solar battery for driving a motor for assisting traveling by human power may be mounted on the bicycle A1.

The terminal device 10 includes a mobile terminal such as what is called a smartphone or a tablet terminal. The terminal device 10 may include a wearable terminal such as a smart watch or a smart tracker, a PC, or the like.

The terminal device 10 generates determination information for determining the proximity state between the port B1 and the bicycle A1 on the basis of a proximity operation #11 (first proximity operation) with the port B1 (non-mobile device) and a proximity operation #12 (second proximity operation) with the bicycle A1 (mobile device). The proximity operation refers to an operation in which the user brings the terminal device 10 close to or holds over the non-mobile device or the mobile device. The determination information is generated on the basis of a physical quantity (first physical quantity) acquired in response to the proximity operation #11 to the non-mobile device and a physical quantity (second physical quantity) acquired in response to the proximity operation #12 to the mobile device. The physical quantities acquired according to the proximity operations #11 and #12 include, for example, time, distance, position, sensor values acquired by various sensors, and the like.

In the proximity operation #11, near field communication (NFC) is performed between the terminal device 10 and the non-mobile device, and the terminal device 10 reads a two-dimensional code of the non-mobile device. By the near field communication between the terminal device 10 and the non-mobile device, the battery-less non-mobile device can be driven by power supplied from the antenna of the terminal device 10 by electromagnetic induction.

In the proximity operation #12, near field communication is performed between the terminal device 10 and the mobile device. By the near field communication between the terminal device 10 and the mobile device, the battery-less mobile device can be driven by power supplied from the antenna of the terminal device 10 by electromagnetic induction.

The authentication server 20 determines the proximity state between the port B1 and the bicycle A1 using the determination information generated by the terminal device 10, and determines whether or not the electronic lock of the bicycle A1 can be locked or unlocked on the basis of the determination result. Specifically, in a case of determining that the port B1 and the bicycle A1 are in proximity to each other, the authentication server 20 determines that the electronic lock of the bicycle A1 can be locked or unlocked.

Furthermore, the authentication server 20 authenticates the port B1 on the basis of the proximity operation #11 between the terminal device 10 and the non-mobile device, and authenticates the bicycle A1 on the basis of the proximity operation #12 between the terminal device 10 and the mobile device.

Specifically, the authentication server 20 authenticates the port B1 on the basis of information acquired by the proximity operation #11. Thereafter, the authentication server 20 determines the proximity state between the port B1 and the bicycle A1 using the determination information generated on the basis of the proximity operation #11 and the proximity operation #12, and authenticates the bicycle A1 on the basis of information acquired by the proximity operation #12.

As described above, in the authentication system of FIG. 2, it is possible to determine the proximity state between the port B1 and the bicycle A1 via the terminal device 10 owned by the user without directly communicating between the non-mobile device and the mobile device that are both battery-less.

### (Functional Configuration Example of Authentication System)

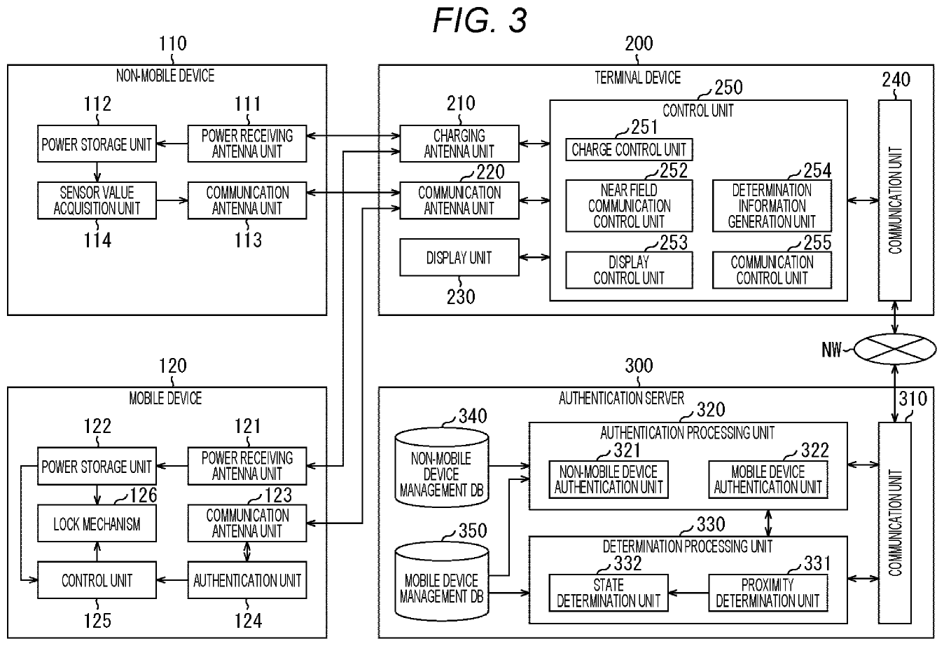

FIG. 3 is a block diagram illustrating a functional configuration example of the authentication system to which the technology according to the present disclosure is applied.

The authentication system in FIG. 3 includes a non-mobile device 110, a mobile device 120, a terminal device 200, and an authentication server 300.

### (1) Configuration of Non-Mobile Device 110

The non-mobile device 110 is configured as, for example, a communication device provided in a port of the share cycle system as described with reference to FIG. 2. Note that the non-mobile device 110 can also be configured as a communication device mounted on a mobile object that is movable and used in a state of being stopped at a predetermined position, other than the port of the share cycle system fixed at a specific position.

The non-mobile device 110 includes a power receiving antenna unit 111, a power storage unit 112, a communication antenna unit 113, and a sensor value acquisition unit 114.

The power receiving antenna unit 111 includes an antenna for near field communication capable of receiving an electromagnetic wave emitted from the terminal device 200, and a communication control circuit. The power receiving antenna unit 111 receives the electromagnetic wave emitted from the terminal device 200, thereby receiving power from the terminal device 200 by electromagnetic induction. The power received by the power receiving antenna unit 111 is accumulated in the power storage unit 112.

The power storage unit 112 includes a capacitor capable of electrostatically storing electric power. For example, the power storage unit 112 is constituted by an electrolytic capacitor which has high pressure resistance and is relatively inexpensive. In a case where the power storage unit 112 is constituted by the electrolytic capacitor, the power storage unit 112 can efficiently store the power received by the power receiving antenna unit 111 without stepping down the power or the like. The electric power accumulated (charged) in the power storage unit 112 is used to drive various sensors constituting the sensor value acquisition unit 114 to be described later, and is not used to transmit the position information of a port in the share cycle system.

The communication antenna unit 113 includes an antenna for near field communication capable of receiving an electromagnetic wave emitted from the terminal device 200, and a communication control circuit. The communication antenna unit 113 performs near field communication with the terminal device 200 to transmit identification information unique to the non-mobile device 110 (port), authentication information used for authentication of the non-mobile device 110, sensor values to be described later, and the like to the terminal device 200.

The sensor value acquisition unit 114 includes various sensors such as a global positioning system (GPS) sensor, an atmospheric pressure sensor, a temperature sensor, an acceleration sensor, and a magnetic sensor, and acquires position information, atmospheric pressure, temperature, acceleration, strength of a magnetic field, and the like as sensor values. The sensor values acquired by the sensor value acquisition unit 114 are transmitted to the terminal device 200 by the communication antenna unit 113.

### (2) Configuration of Mobile Device 120

The mobile device 120 is configured as, for example, a communication device mounted on a bicycle of the share cycle system as described with reference to FIG. 2.

The mobile device 120 includes a power receiving antenna unit 121, a power storage unit 122, a communication antenna unit 123, an authentication unit 124, a control unit 125, and a lock mechanism 126.

The power receiving antenna unit 121 includes an antenna for near field communication capable of receiving an electromagnetic wave emitted from the terminal device 200, and a communication control circuit. The power receiving antenna unit 121 receives the electromagnetic wave emitted from the terminal device 200, thereby receiving power from the terminal device 200 by electromagnetic induction. The power received by the power receiving antenna unit 121 is accumulated in the power storage unit 122.

The power storage unit 122 includes a capacitor capable of electrostatically storing electric power. For example, the power storage unit 122 is constituted by an electrolytic capacitor which has high pressure resistance and is relatively inexpensive. In a case where the power storage unit 122 is constructed by the electrolytic capacitor, the power storage unit 122 can efficiently store the power received by power receiving antenna unit 121 without stepping down the power or the like. The electric power accumulated (charged) in the power storage unit 122 is used for locking/unlocking of the lock mechanism 126 described later, and is not used for communication/authentication with the authentication server 300 of the bicycle in the share cycle system.

The communication antenna unit 123 includes an antenna for near field communication capable of receiving an electromagnetic wave emitted from the terminal device 200, and a communication control circuit. The communication antenna unit 123 performs near field communication with the terminal device 200 to transmit identification information unique to the mobile device 120 (bicycle), authentication information used for authentication of the mobile device 120, a state of the power storage unit 122, a state of the lock mechanism 126 to be described later, and the like to the terminal device 200. Furthermore, the communication antenna unit 123 performs near field communication with the terminal device 200 to receive authentication information for authenticating the authentication server 300 from the terminal device 200.

The authentication unit 124 authenticates the authentication server 300 using the authentication information from the terminal device 200.

The control unit 125 includes, for example, a microprocessor and controls the overall operation of the mobile device 120.

The control unit 125 controls locking/unlocking of the lock mechanism 126 on the basis of the authentication result of the authentication server 300 by the authentication unit 124. For example, in a case where the authentication of the authentication server 300 is successful and the amount of power (charge amount) accumulated in the power storage unit 122 has reached the amount of power necessary for locking/unlocking the lock mechanism 126, the control unit 125 executes locking/unlocking of the lock mechanism 126. A notification of the charge amount of the power storage unit 122 may be given to the terminal device 200 via communication by the communication antenna unit 123, for example.

The lock mechanism 126 is configured as what is called an electronic lock, and includes, for example, a mechanism that prevents a wheel of a bicycle from rotating. The lock mechanism 126 switches between a state in which the wheel is non-rotatable (that is, a locked state) and a state in which the wheel is rotatable (that is, an unlocked state) by a physical mechanism on the basis of the control by the control unit 125.

### (3) Configuration of Terminal Device 200

The terminal device 200 is configured as, for example, a smartphone of a user who uses the share cycle system as described with reference to FIG. 2.

The terminal device 200 includes a charging antenna unit 210, a communication antenna unit 220, a display unit 230, a communication unit 240, and a control unit 250.

The charging antenna unit 210 includes an antenna for near field communication such as near field communication, and a communication control circuit.

The charging antenna unit 210 irradiates the non-mobile device 110 with electromagnetic waves by a proximity operation with the non-mobile device 110, thereby supplying power to the non-mobile device 110. The electric power supplied to the non-mobile device 110 is accumulated in the power storage unit 112 of the non-mobile device 110. Furthermore, the charging antenna unit 210 irradiates the mobile device 120 with electromagnetic waves by a proximity operation with the mobile device 120, thereby supplying power to the mobile device 120. The electric power supplied to the mobile device 120 is accumulated in the power storage unit 122 of the mobile device 120.

The communication antenna unit 220 includes an antenna for near field communication such as near field communication, and a communication control circuit.

The communication antenna unit 220 communicates with the non-mobile device 110 to receive the identification information and the authentication information of the non-mobile device 110. Furthermore, the communication antenna unit 220 communicates with the mobile device 120 to receive the identification information and the authentication information of the mobile device 120 and transmit authentication information and an execution request of the authentication server 300.

The display unit 230 presents various screens to the user on the basis of control by the control unit 250. The display unit 230 includes, for example, a display device such as a liquid crystal display (LCD), a plasma display panel (PDP), or an organic light emitting diode (OLED) display. The display unit 230 may be a touch panel in which a display device such as an LCD and a position input device such as a touch pad are integrated.

The communication unit 240 is a communication interface including a communication device for connecting to a network NW such as the Internet. The terminal device 200 can supply information acquired from the non-mobile device 110 and information acquired from the mobile device 120 to the authentication server 300 by communicating with the authentication server 300 by the communication unit 240.

The control unit 250 controls the overall operation of the terminal device 200.

The control unit 250 includes a charge control unit 251, a near field communication control unit 252, a display control unit 253, a determination information generation unit 254, and a communication control unit 255.

The charge control unit 251 controls charging of the power storage unit 112 of the non-mobile device 110 and the power storage unit 122 of the mobile device 120 by controlling irradiation of the non-mobile device 110 and the mobile device 120 with electromagnetic waves by the charging antenna unit 210.

The near field communication control unit 252 controls transmission and reception of information to and from the non-mobile device 110 and the mobile device 120 by the communication antenna unit 220.

The display control unit 253 controls display of a screen on the display unit 230. For example, the display control unit 253 causes the display unit 230 to display a screen corresponding to a proximity operation with the non-mobile device 110 or the mobile device 120 or a screen corresponding to an authentication result of the non-mobile device 110 or the mobile device 120 by the authentication server 300.

The determination information generation unit 254 generates determination information for determining the proximity state between the non-mobile device 110 and the mobile device 120 on the basis of the physical quantity acquired in response to the proximity operation with the non-mobile device 110 and the physical quantity acquired in response to the proximity operation with the mobile device 120.

As described above, the physical quantity acquired in response to the proximity operation includes, for example, time, distance, position, sensor values acquired by various sensors, and the like. These physical quantities are sensor values acquired by the non-mobile device 110 or sensor values acquired by various sensors of the terminal device 200 at the timing of the proximity operation between the terminal device 200 and the mobile device 120.

The generated determination information is transmitted to the authentication server 300 by the communication unit 240 via the network NW.

The communication control unit 255 controls transmission and reception of information to and from the authentication server 300 by the communication unit 240.

### (4) Configuration of Authentication Server 300

The authentication server 300 is configured as, for example, a management server that manages renting/returning of bicycles in the share cycle system as described with reference to FIG. 2.

The authentication server 300 includes a communication unit 310, an authentication processing unit 320, a determination processing unit 330, a non-mobile device management DB 340, and a mobile device management DB 350.

The communication unit 310 is a communication interface including a communication device for connecting to the network NW. The authentication server 300 can acquire information from the non-mobile device 110 and information from the mobile device 120 by communicating with the terminal device 200 by the communication unit 310.

The authentication processing unit 320 performs processing related to authentication of the non-mobile device 110 and the mobile device 120. The authentication processing unit 320 includes a non-mobile device authentication unit 321 and a mobile device authentication unit 322.

The non-mobile device authentication unit 321 authenticates the non-mobile device 110 on the basis of information from the non-mobile device 110 acquired by the communication unit 310 and information held in the non-mobile device management DB 340. Here, unidirectional authentication of the non-mobile device 110 is performed.

The mobile device authentication unit 322 authenticates the mobile device 120 on the basis of the information from the mobile device 120 acquired by the communication unit 310 and the information held in the mobile device management DB 350. On the other hand, in the mobile device 120, authentication of the authentication server 300 is performed. That is, bidirectional authentication with the mobile device 120 is performed here.

The determination processing unit 330 performs determination processing related to a proximity state between the non-mobile device 110 and the mobile device 120 and locking/unlocking of the lock mechanism 126 of the mobile device 120. The determination processing unit 330 includes a proximity determination unit 331 and a state determination unit 332.

The proximity determination unit 331 determines the proximity state between the non-mobile device 110 and the mobile device 120 using the determination information from the terminal device 200 received by the communication unit 310. The determination result of the proximity state is supplied to the authentication processing unit 320, and the authentication processing unit 320 (mobile device authentication unit 322) authenticates the mobile device 120 according to the determination result of the proximity state. The determination result of the proximity state is also supplied to the state determination unit 332.

The state determination unit 332 determines the state (specifically, whether or not locking/unlocking of the lock mechanism 126 is possible) of the lock mechanism 126 of the mobile device 120 on the basis of the determination result of the proximity state from the proximity determination unit 331. In a case where it is determined that the locking/unlocking of the lock mechanism 126 is possible, a locking/unlocking execution request of the lock mechanism 126 is transmitted to the mobile device 120 via the communication unit 310, the network NW, and the terminal device 200.

The non-mobile device management DB 340 is configured as a port DB that manages information regarding each of a plurality of ports (non-mobile devices 110) belonging to the share cycle system. The mobile device management DB 350 is configured as a bicycle DB that manages information regarding each of a plurality of bicycles (mobile devices 120) belonging to the share cycle system.

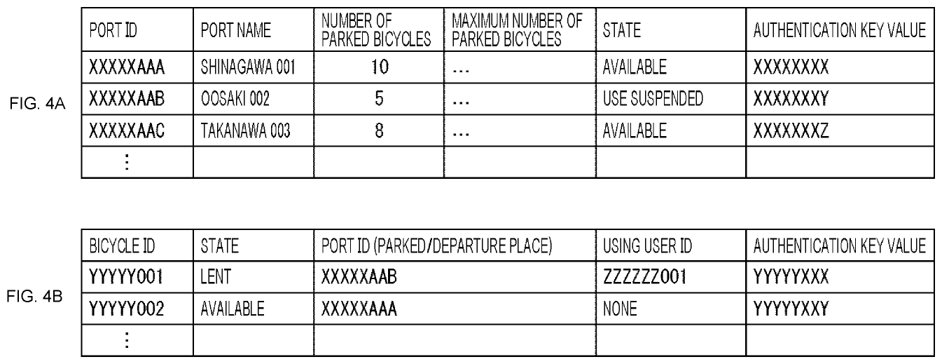

FIG. 4 is a diagram illustrating an example of a port DB (non-mobile device management DB 340) and a bicycle DB (mobile device management DB 350).

In the port DB illustrated at A of FIG. 4, respective pieces of information of “port name”, “number of parked bicycles”, “maximum number of parked bicycles”, “state”, and “authentication key value” are held as records using “port ID” that is identification information specific to a port as a key. “Port name” represents a name of a port identified by the port ID. The “number of parked bicycles” represents the number of bicycles currently parked at the port, and the “maximum number of bicycles” represents the maximum number of bicycles that can be parked at the port. The “state” indicates availability of the port. The “authentication key value” is authentication information (common key) used for authentication of the port, and is set every time the port is authenticated.

For example, the port with the port ID “XXXXXAAA” has the port name “Shinagawa 001”, the number of parked bicycles “10”, the status “available”, and the authentication key value “XXXXXXXX”.

The non-mobile device authentication unit 321 can perform authentication of the port (non-mobile device 110) by acquiring each piece of information of the records of the corresponding port ID in the port DB using the port ID from the non-mobile device 110.

In the bicycle DB illustrated at B of FIG. 4, respective pieces of information of “state”, “port ID”, “using user ID”, and “authentication key value” are set as records using “bicycle ID” that is identification information unique to a bicycle as a key. “State” indicates a rental state of the bicycle identified by the bicycle ID. The “port ID” represents the port ID of a port where the bicycle is parked or lent. The “using user ID” is identification information unique to the user in a case where the bicycle is lent out. The “authentication key value” is authentication information (common key) used for authentication of the bicycle, and is set every time the bicycle is authenticated.

For example, the bicycle with a bicycle ID “YYYYY002” has a state of “available”, a port ID “XXXXXAAA”, a using user ID “none”, and an authentication key value “YYYYYXXY”.

The mobile device authentication unit 322 can perform authentication of the bicycle (mobile device 120) by acquiring each piece of information of the records of the corresponding bicycle ID in the bicycle DB using the bicycle ID from the mobile device 120.

### <3. Operation of Authentication System>

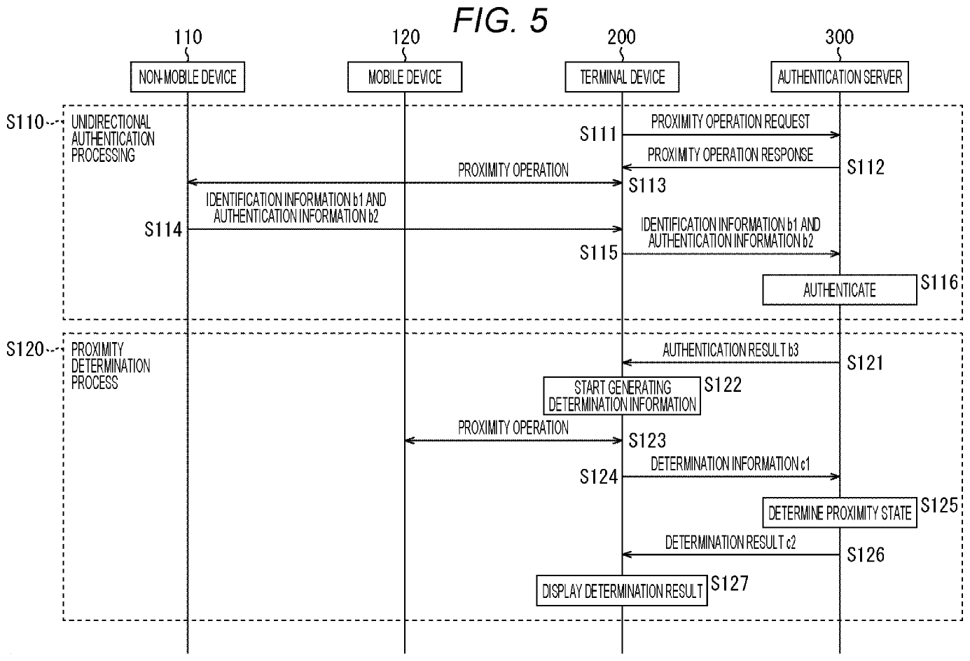

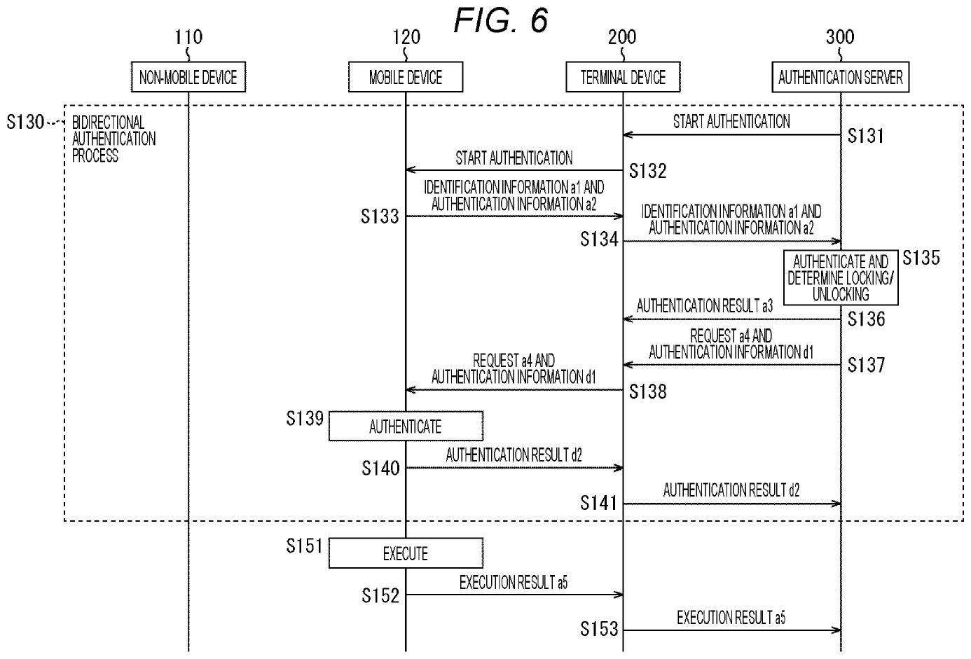

The overall flow of the operation of the authentication system of FIG. 4 will be described with reference to FIGS. 5 and 6. The processing of FIGS. 5 and 6 is started, for example, by activating an application for renting/returning a bicycle in a share cycle system installed in the terminal device 200 (smartphone).

First, in step S110, unidirectional authentication processing of the non-mobile device 110 is performed.

Specifically, in step S111, the terminal device 200 (communication antenna unit 220) transmits a proximity operation request to the authentication server 300 in response to operation of a screen or the like displayed on the display unit 230 by the user of the terminal device 200.

In step S112, the authentication server 300 (communication unit 310) transmits a proximity operation response with respect to the proximity operation request from the terminal device 200 to the terminal device 200. The proximity operation response is a command that permits the user of the terminal device 200 to perform near field communication by bringing the terminal device 200 close to the non-mobile device 110 (port).

Furthermore, in step S112, a “challenge” which is a data sequence different every time based on a random number may be transmitted together with the proximity operation response. The challenge is converted to a message authentication code (MAC) in accordance with a particular algorithm at the non-mobile device 110 and returned as a “response”.

In step S113, the terminal device 200 (communication antenna unit 220) performs near field communication with the non-mobile device 110 (port) when the user of the terminal device 200 performs a proximity operation. Specifically, the terminal device 200 transmits the challenge from the authentication server 300 to the non-mobile device 110.

In step S114, the non-mobile device 110 transmits identification information b1 and authentication information b2 to the terminal device 200 in response to reception of the challenge from the terminal device 200.

The identification information b1 is the port ID described above, and the authentication information b2 is a MAC calculated on the basis of the challenge.

In step S115, the terminal device 200 (communication unit 240) transmits the identification information b1 and the authentication information b2 from the non-mobile device 110 to the authentication server 300.

In step S116, the authentication server 300 (non-mobile device authentication unit 321) authenticates the non-mobile device 110 using the identification information b1 and the authentication information b2 from the non-mobile device 110. Specifically, the authentication server 300 calculates a MAC on the basis of the transmitted challenge, and verifies a match with the MAC from the non-mobile device 110. In a case where the respective MACs coincide with each other, the authentication server 300 determines that the authentication of the non-mobile device 110 succeeds.

When the authentication of the non-mobile device 110 succeeds, proximity determination processing of the non-mobile device 110 and the mobile device 120 is performed in step S120.

Specifically, in step S121, the authentication server 300 (communication unit 310) transmits an authentication result b3 of the non-mobile device 110 to the terminal device 200.

In step S122, the terminal device 200 (determination information generation unit 254) starts generating the determination information by receiving the authentication result b3 indicating that the authentication of the non-mobile device 110 is successful from the authentication server 300. At this time, a screen prompting the user of the terminal device 200 to bring the terminal device 200 close to the mobile device 120 (bicycle) is displayed on the display unit 230 of the terminal device 200.

That is, in step S123, the terminal device 200 (communication antenna unit 220) performs near field communication with the mobile device 120 (bicycle) by the user of the terminal device 200 performing proximity operation.

Thereafter, it is assumed that the proximity operation between the terminal device 200 and the mobile device 120 is continued.

After a lapse of a predetermined time from the start of generation of the determination information, in step S124, the terminal device 200 (communication unit 240) transmits determination information c1 generated at that time to the authentication server 300.

In step S125, the authentication server 300 (proximity determination unit 331) determines the proximity state between the non-mobile device 110 and the mobile device 120 using the determination information c1 generated in the terminal device 200.

In step S126, the authentication server 300 (communication unit 310) transmits determination result c2 of the proximity state between the non-mobile device 110 and the mobile device 120 to the terminal device 200.

In step S127, the terminal device 200 (display unit 230) displays the determination result c2 from the authentication server 300.

In a case where the determination result c2 indicates that the non-mobile device 110 and the mobile device 120 are not in proximity, the proximity determination processing in step S120 is repeated. On the other hand, in a case where the determination result c2 indicates that the non-mobile device 110 and the mobile device 120 are in proximity, bidirectional authentication processing between the authentication server 300 and the mobile device 120 is performed in step S130 (FIG. 6).

Hereinafter, it is assumed that the bidirectional authentication processing between the authentication server 300 and the mobile device 120 is performed in a state where the proximity operation between the terminal device 200 and the mobile device 120 is continued.

Specifically, in step S131, the authentication server 300 (communication unit 310) transmits an instruction to start authentication of the mobile device 120 to the terminal device 200. Specifically, the authentication server 300 transmits the challenge described above as an instruction to start authentication.

In step S132, the terminal device 200 (communication antenna unit 220) performs near field communication with the mobile device 120 (bicycle), thereby transmitting a challenge from the authentication server 300 to the mobile device 120 as an instruction to start authentication of the mobile device 120.

In step S133, the mobile device 120 transmits identification information a1 and authentication information a2 to the terminal device 200 in response to reception of the challenge from the terminal device 200. The identification information a1 is the bicycle ID described above, and the authentication information a2 is a MAC calculated on the basis of the challenge. At this time, the mobile device 120 transmits another challenge to the terminal device 200 together with the identification information a1 and the authentication information a2.

In step S134, the terminal device 200 (communication unit 240) transmits the identification information a1 and the authentication information a2 from the non-mobile device 110 and the challenge to the authentication server 300.

In step S135, the authentication server 300 (mobile device authentication unit 322) authenticates the mobile device 120 using the identification information a1 and the authentication information a2 from the mobile device 120. Specifically, the authentication server 300 calculates a MAC on the basis of the transmitted challenge, and verifies a match with the MAC from the mobile device 120. In a case where the respective MACs coincide with each other, the authentication server 300 determines that the authentication of mobile device 120 succeeds.

Furthermore, in step S135, the authentication server 300 (state determination unit 332) determines whether or not the locking/unlocking of the lock mechanism 126 of the mobile device 120 is possible on the basis of the determination result of the proximity state by the proximity determination unit 331.

In step S136, the authentication server 300 (communication unit 310) transmits an authentication result a3 of the mobile device 120 to the terminal device 200.

Subsequently, in step S137, the authentication server 300 (communication unit 310) transmits a locking/unlocking execution request a4 according to that locking/unlocking of the lock mechanism 126 is possible and authentication information d1 used for authentication of the authentication server 300 to the terminal device 200. The authentication information d1 is a MAC calculated on the basis of the challenge from the mobile device 120.

In step S138, in response to reception of the authentication result a3 from the authentication server 300, the terminal device 200 (communication antenna unit 220) transmits the request a4 from the authentication server 300 and the authentication information d1 to the mobile device 120.

In step S139, the mobile device 120 authenticates the authentication server 300 using the authentication information d1 from the authentication server 300. Specifically, the mobile device 120 (authentication unit 124) calculates a MAC on the basis of the transmitted challenge, and verifies a match with the MAC from the authentication server 300. In a case where the respective MACs coincide with each other, the mobile device 120 determines that the authentication of the authentication server 300 succeeds.

In step S140, the mobile device 120 transmits an authentication result d2 of the authentication server 300 to the terminal device 200.

In step S141, the terminal device 200 (communication unit 240) transmits the authentication result d2 from the mobile device 120 to the authentication server 300.

In this way, the bidirectional authentication processing (step S130) between the authentication server 300 and the mobile device 120 is completed in a state where the proximity operation between the terminal device 200 and the mobile device 120 is continued.

In step S151, the mobile device 120 (control unit 125) executes locking/unlocking of the lock mechanism 126 in response to the successful authentication of the authentication server 300 and the request a4 from the authentication server 300.

In step S152, the mobile device 120 transmits a locking/unlocking execution result a5 of the lock mechanism 126 to the terminal device 200.

In step S153, the terminal device 200 (communication unit 240) transmits the execution result a5 from the mobile device 120 to the authentication server 300.

In the above flow, in the share cycle system to which the authentication system of FIG. 4 is applied, the non-mobile device 110 is authenticated, the proximity determination between the non-mobile device 110 and the mobile device 120 is performed, and the mobile device 120 is authenticated, whereby the bicycle is rent/returned. However, the proximity determination processing (step S120) of the non-mobile device 110 and the mobile device 120 and the bidirectional authentication processing (step S130) of the mobile device 120 may be executed in the order opposite to the above-described flow.

Note that the authentication (unidirectional authentication) of the non-mobile device 110 is not necessarily performed by near field communication. Specifically, reading of a code such as a two-dimensional code of the non-mobile device 110 by the terminal device 200 may be performed instead of near field communication in response to the proximity operation of the terminal device 200 with the non-mobile device 110. Furthermore, a Bluetooth (registered trademark) signal or an ultra wide band (UWB) signal from a tag of the non-mobile device 110 may be received by the terminal device 200 in response to a proximity operation of the terminal device 200 with the non-mobile device 110. Moreover, image acquisition (imaging) and sound acquisition (recording) around the non-mobile device 110 may be performed by the terminal device 200 in response to a proximity operation of the terminal device 200 with the non-mobile device 110.

By the code reading, the reception of the Bluetooth signal or the UWB signal, and the image acquisition and sound acquisition, the authentication server 300 can acquire identification information of the non-mobile device 110 and verify the identification information. Thus, the non-mobile device 110 on which the proximity operation with the terminal device 200 has been performed can be specified.

### <4. Operation and UI of Terminal Device>

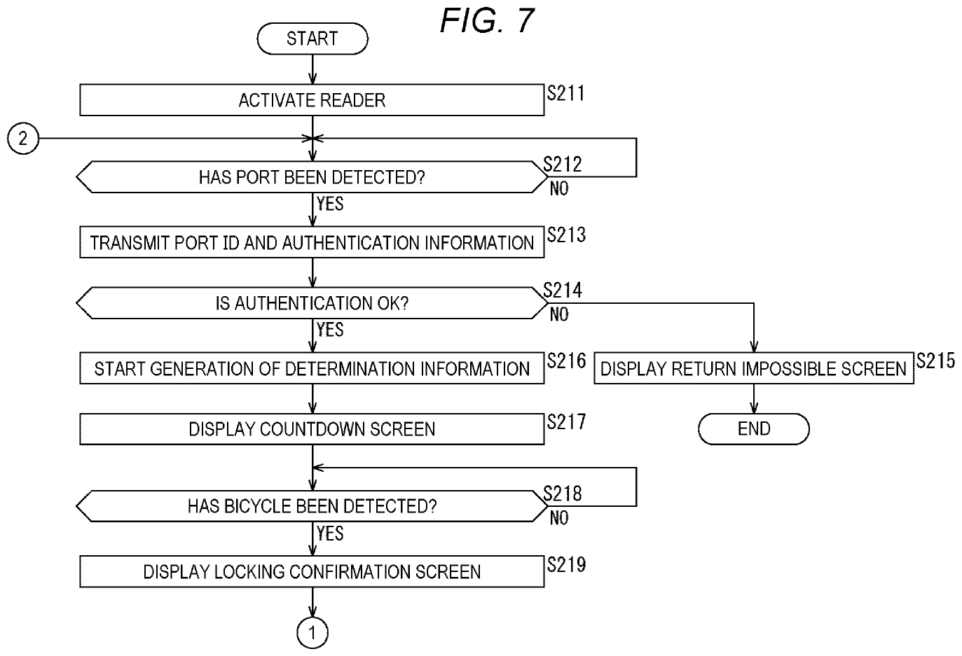

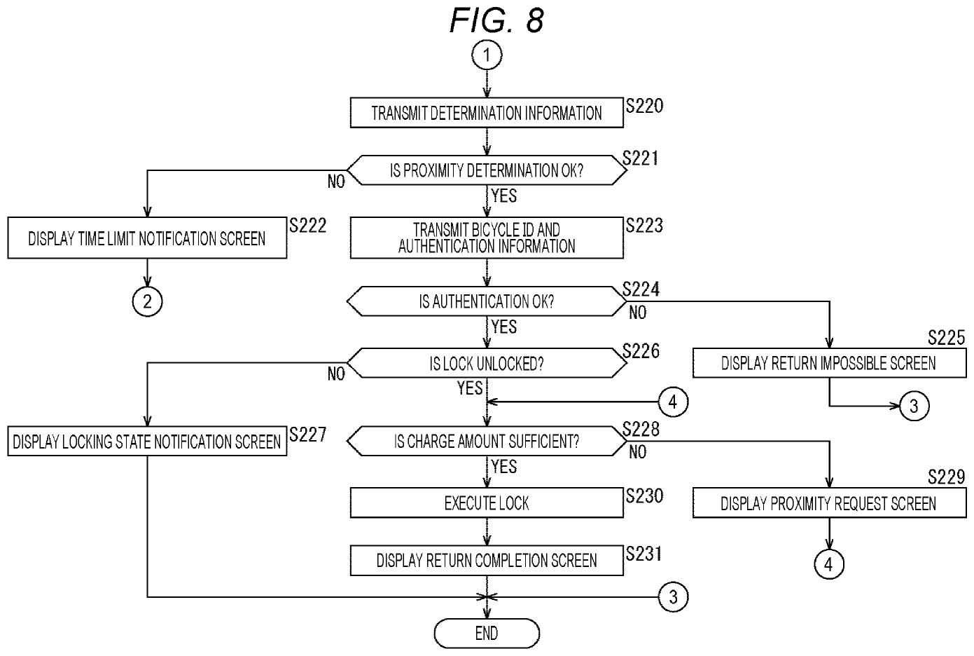

The operation of the terminal device 200 and a user interface (UI) in the overall flow of the operation of the authentication system in FIGS. 5 and 6 will be described with reference to FIGS. 7 and 8. The processing in FIGS. 7 and 8 is started when the terminal device 200 receives, for example, the proximity operation response (step S112 in FIG. 5) from the authentication server 300. Note that the processing in FIGS. 7 and 8 is processing executed when the user who owns the terminal device 200 returns the bicycle to the port in the share cycle system.

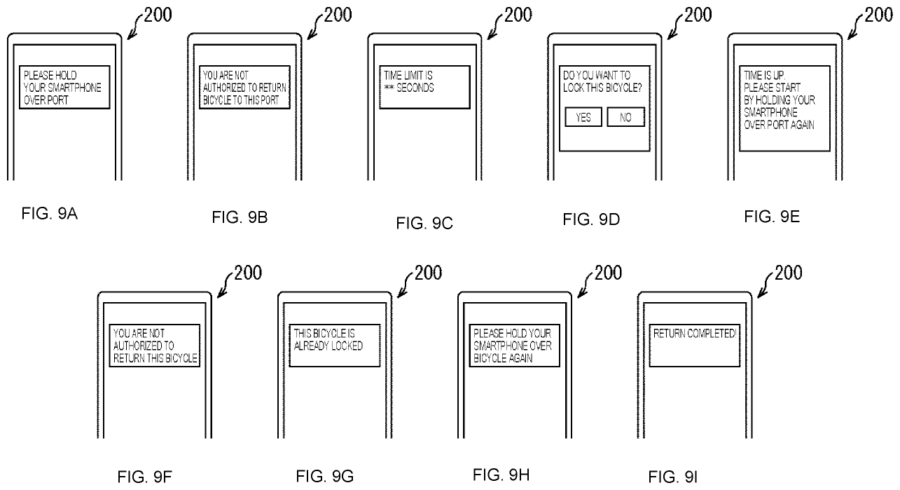

In step S211, the control unit 250 activates a reader. The reader referred to herein is an NFC reader (reader/writer) including the communication antenna unit 220. At this time, on the display unit 230 of the terminal device 200, for example, as illustrated at A of FIG. 9, a screen prompting the user to bring the terminal device 200 close to the non-mobile device 110 (port) including a message such as “hold the smartphone over the port” is displayed.

Note that, in a case where near field communication is not performed between the terminal device 200 and the non-mobile device 110, the reader may be a code reader for code reading or may be a reception unit of a Bluetooth signal or a UWB signal. Furthermore, the reader may be a camera for image acquisition or a microphone for sound acquisition.

In the following description, it is assumed that near field communication is performed between the terminal device 200 and the non-mobile device 110.

In step S212, the near field communication control unit 252 determines whether or not a port (non-mobile device 110) has been detected. Step S212 is repeated until it is determined that the port is detected. Then, when it is determined that the port is detected as the terminal device 200 approaches the non-mobile device 110, the communication antenna unit 220 receives the port ID and the authentication information from the non-mobile device 110, and the process proceeds to step S213.

In step S213, the communication control unit 255 controls the communication unit 240 to transmit the port ID and the authentication information from the non-mobile device 110 to the authentication server 300. In the authentication server 300, when the non-mobile device 110 is authenticated on the basis of the port ID and the authentication information, the communication unit 240 receives the authentication result, and the process proceeds to step S214.

In step S214, the control unit 250 determines whether or not the authentication is OK (the authentication is successful) on the basis of the authentication result from the authentication server 300. In a case where it is determined in step S214 that the authentication is not OK (the authentication is NG (no good)), the process proceeds to step S215.

In step S215, for example, as illustrated in B of FIG. 9, the display control unit 253 causes the display unit 230 to display a return impossible screen including a message such as “you are not authorized to return the bicycle to this port”. In this case, the port where the user has performed the proximity operation of the terminal device 200 is a port where the bicycle should not be returned (wrong port).

On the other hand, in a case where the authentication is determined to be OK in step S214, that is, in a case where the port where the user has performed the proximity operation of the terminal device 200 is the correct port, the process proceeds to step S216.

In step S216, the determination information generation unit 254 starts generation of determination information for determining the proximity state between the non-mobile device 110 and the mobile device 120.

Subsequently, in step S217, the display control unit 253 causes the display unit 230 to display a countdown screen including a message such as “time limit is ◯◯ seconds”, for example, as illustrated in C of FIG. 9. The countdown screen is a screen prompting the user to bring the terminal device 200 close to the mobile device 120 (bicycle) within a predetermined time.

In step S218, the near field communication control unit 252 determines whether or not a bicycle (mobile device 120) is detected. Step S218 is repeated until it is determined that the bicycle is detected. Then, when it is determined that the bicycle is detected as the terminal device 200 approaches the mobile device 120, the process proceeds to step S219.

In step S219, the display control unit 253 causes the display unit 230 to display a locking confirmation screen including a message such as “do you want to lock this bicycle?” as illustrated in D of FIG. 9, for example. The locking confirmation screen is provided with a “Yes” button for selecting that the user returns the bicycle to which the terminal device 200 is brought close to the port and a “No” button for selecting that the user does not return the bicycle to the port. When the “YES” button is selected, the process proceeds to step S220 (FIG. 8).

In step S220, the communication control unit 255 controls the communication unit 240 to transmit the determination information generated at that time to the authentication server 300. When the proximity determination of the non-mobile device 110 and the mobile device 120 is performed using the determination information in the authentication server 300, the communication unit 240 receives the determination result and proceeds to step S221.

In step S221, the control unit 250 determines whether or not the proximity determination is OK (the non-mobile device 110 and the mobile device 120 are in proximity) on the basis of the determination result from the authentication server 300. In a case where it is determined in step S221 that the proximity determination is not OK (the proximity determination is NG), the process proceeds to step S222.

In step S222, for example, as illustrated in E of FIG. 9, the display control unit 253 causes the display unit 230 to display a time limit notification screen including a message such as “Time is up. Please start by holding the smartphone over the port again”. The time limit notification screen is a screen for notifying the user that the terminal device 200 has not been brought close to the mobile device 120 (bicycle) within a predetermined time. After step S222, the process returns to step S212, and the processes after the determination of the detection of the port are repeated.

On the other hand, in a case where it is determined in step S221 that the proximity determination is OK, the communication antenna unit 220 receives the bicycle ID and the authentication information from the mobile device 120, and the process proceeds to step S223. The authentication information received from the mobile device 120 includes the state of the lock mechanism 126 (locked/unlocked state) and the charge amount of the power storage unit 122.

In step S223, the communication control unit 255 controls the communication unit 240 to transmit the bicycle ID and the authentication information from the mobile device 120 to the authentication server 300. In the authentication server 300, when the mobile device 120 is authenticated on the basis of the bicycle ID and the authentication information, the communication unit 240 receives the authentication result, and the process proceeds to step S224.

In step S224, the control unit 250 determines whether or not the authentication is OK (the authentication is successful) on the basis of the authentication result from the authentication server 300. In a case where it is determined in step S224 that the authentication is not OK, the process proceeds to step S225.

In step S225, for example, as illustrated in F of FIG. 9, the display control unit 253 causes the display unit 230 to display a non-return screen including a message such as “You are not authorized to return this bicycle”. In this case, the bicycle on which the user has performed the proximity operation of the terminal device 200 is a bicycle that should not be returned to the port.

On the other hand, in a case where it is determined in step S224 that the authentication is OK, that is, in a case where the bicycle on which the user has performed the proximity operation of the terminal device 200 is a bicycle to be returned to the port, the process proceeds to step S226. At this time, an authentication result indicating authentication OK is transmitted from the authentication server 300, and a lock request of the lock mechanism 126 is transmitted in response to that it is determined by the state determination unit 332 that the lock mechanism 126 can be locked.

In step S226, the control unit 250 determines whether or not the lock mechanism 126 is unlocked on the basis of the state of the lock mechanism 126 included in the authentication information received from the mobile device 120. In a case where it is determined in step S226 that the lock mechanism 126 is not unlocked, the process proceeds to step S227.

In step S227, for example, as illustrated in G of FIG. 9, the display control unit 253 causes the display unit 230 to display a locking state notification screen including a message such as “this bicycle is already locked”. That is, since the bicycle has been returned to the port, the process ends after step S227.

On the other hand, in a case where it is determined in step S226 that the lock mechanism 126 is unlocked, the process proceeds to step S228.

Note that the authentication server 300 may determine whether or not the lock mechanism 126 is unlocked based on the state of the lock mechanism 126 included in the authentication information of the mobile device 120 in step S226. In this case, the mobile device authentication unit 322 determines that the lock mechanism 126 is unlocked on the basis of the state of the lock mechanism 126, thereby determining that the mobile device 120 (bicycle) is authenticated OK.

In step S228, the control unit 250 determines whether or not the charge amount of the power storage unit 122 is sufficient to lock the lock mechanism 126 on the basis of the charge amount of the power storage unit 122 included in the authentication information received from the mobile device 120. In a case where it is determined in step S228 that the charge amount of the power storage unit 122 is not sufficient, the process proceeds to step S229.

In step S229, for example, as illustrated at H of FIG. 9, the display control unit 253 causes the display unit 230 to display a proximity request screen including a message such as “please hold your smartphone over the bicycle again”. The proximity request screen is a screen prompting the user to further power supply from the terminal device 200 to the mobile device 120 by bringing the terminal device 200 close to the mobile device 120 (bicycle) again. After step S229, the process returns to step S228, and steps S228 and S229 are repeated until it is determined that the charge amount of the power storage unit 122 is sufficient. That is, the power storage unit 122 is charged by the proximity operation of the terminal device 200, and the proximity operation of the terminal device 200 is continued until the charge amount becomes an amount sufficient to lock the lock mechanism 126.

On the other hand, in a case where it is determined in step S229 that the charge amount of the power storage unit 122 is sufficient, the process proceeds to step S230.

Note that the determination as to whether or not the charge amount of the power storage unit 122 is sufficient based on the charge amount of the power storage unit 122 included in the authentication information of the mobile device 120 in step S228 may be performed in the authentication server 300. In this case, the mobile device authentication unit 322 determines that the charge amount of the power storage unit 122 is sufficient on the basis of the charge amount of the power storage unit 122, thereby determining that the mobile device 120 (bicycle) is authenticated OK.

In step S230, the near field communication control unit 252 controls the communication antenna unit 220 to transmit a lock request of the lock mechanism 126 from the authentication server 300 to the mobile device 120. Thus, locking of the lock mechanism 126 is executed in the mobile device 120.

Thereafter, in step S231, the display control unit 253 causes the display unit 230 to display a return completion screen including a message such as “return completed!” as illustrated at I of FIG. 9, for example.

In the terminal device 200, the processing as above is executed when the user returns the bicycle to the port in the share cycle system.

Note that when the bicycle is lent out to the user in the share cycle system, unlocking is executed instead of locking the lock mechanism 126 in the processing of FIGS. 7 and 8.

### <5. Specific Example of Proximity Determination Processing>

Hereinafter, a specific example of the proximity determination processing (step S120) of the non-mobile device 110 and the mobile device 120 by the authentication server 300 in the overall flow of the operation of the authentication system of FIGS. 5 and 6 will be described.

### First Specific Example

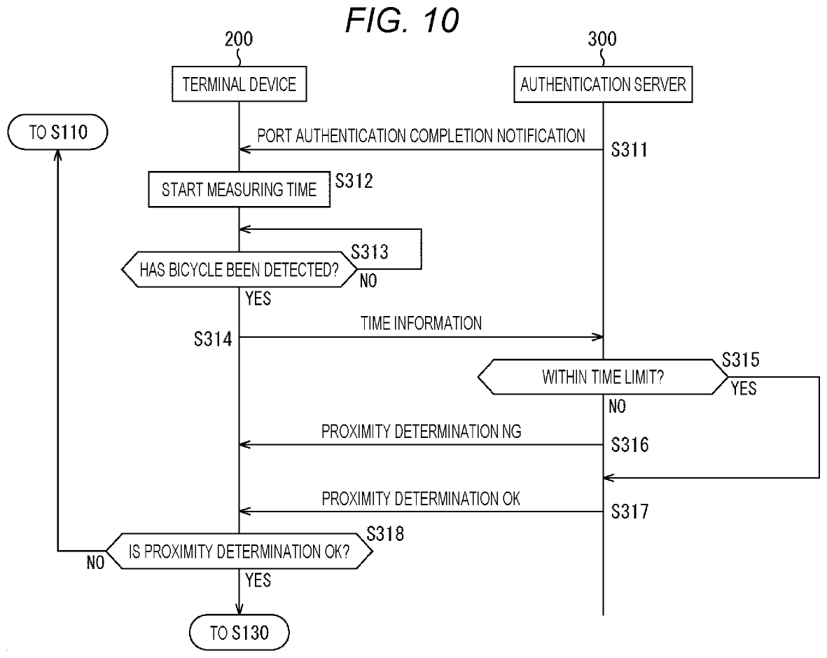

FIG. 10 is a diagram illustrating a first specific example of proximity determination processing of the non-mobile device 110 and the mobile device 120.

In the first specific example, as the determination information, time information indicating the time from the time related to the proximity operation with the non-mobile device 110 (port) to the time related to the proximity operation with the mobile device 120 (bicycle) is generated by the terminal device 200 and transmitted to the authentication server 300.

First, in step S311, as a result of the proximity operation with the non-mobile device 110, the authentication server 300 (communication unit 310) transmits a port authentication completion notification indicating that the authentication of the non-mobile device 110 (port) is completed to the terminal device 200.

In step S312, the terminal device 200 (determination information generation unit 254) starts measuring the time from the time when the port authentication completion notification from the authentication server 300 is received. Note that the time when the measurement of the time is started is not limited to the time when the port authentication completion notification is received, and may be the time when near field communication with the non-mobile device 110 is started, the time when code reading is performed, or the time when the Bluetooth signal or the UWB signal from the tag is received. Furthermore, the time at which the measurement of the time is started may be a time designated by the user at the time of the proximity operation with the non-mobile device 110.

In step S313, the terminal device 200 (near field communication control unit 252) determines whether or not a bicycle has been detected by near field communication accompanying a proximity operation with the mobile device 120 (bicycle). Whether or not the bicycle has been detected is determined by whether or not an ACK response has been received from the mobile device 120.

Step S313 is repeated until it is determined that the bicycle has been detected. When it is determined that the bicycle is detected, the determination information generation unit 254 stops the measurement of the time, and the process proceeds to step S314.

In step S314, the terminal device 200 (communication unit 240) transmits time information indicating the time from the time when the port authentication completion notification from the authentication server 300 is received to the time when the ACK response is received from the mobile device 120 to the authentication server 300 as the determination information.

In step S315, the authentication server 300 (proximity determination unit 331) determines whether or not the time indicated by the time information from the terminal device 200 is within the time limit, thereby determining the proximity state between the non-mobile device 110 and the mobile device 120.

In a case where it is determined that the time indicated by the time information has exceeded the time limit, in step S316, the authentication server 300 (communication unit 310) transmits a notification that proximity determination is NG to the terminal device 200.

On the other hand, in a case where it is determined that the time indicated by the time information has exceeded the time limit, in step S317, the authentication server 300 (communication unit 310) transmits a notification indicating that the proximity determination is OK to the terminal device 200.

In step S318, the terminal device 200 (control unit 250) determines whether or not the proximity determination is OK on the basis of the notification received from the authentication server 300.

When it is determined that the proximity determination is not OK, that is, the proximity determination is NG, the process returns to step S110 (authentication processing of the non-mobile device 110). That is, the user again performs the proximity operation between the terminal device 200 and the non-mobile device 110 (port).

On the other hand, when it is determined that the proximity determination is OK, the proximity determination processing of the non-mobile device 110 and the mobile device 120 ends, and the process proceeds to step S130 (authentication processing of the mobile device 120).

In this way, it is grasped that the bicycle is present near the port on the basis of the time from the time related to the proximity operation with the port to the time related to the proximity operation with the bicycle.

### Second Specific Example

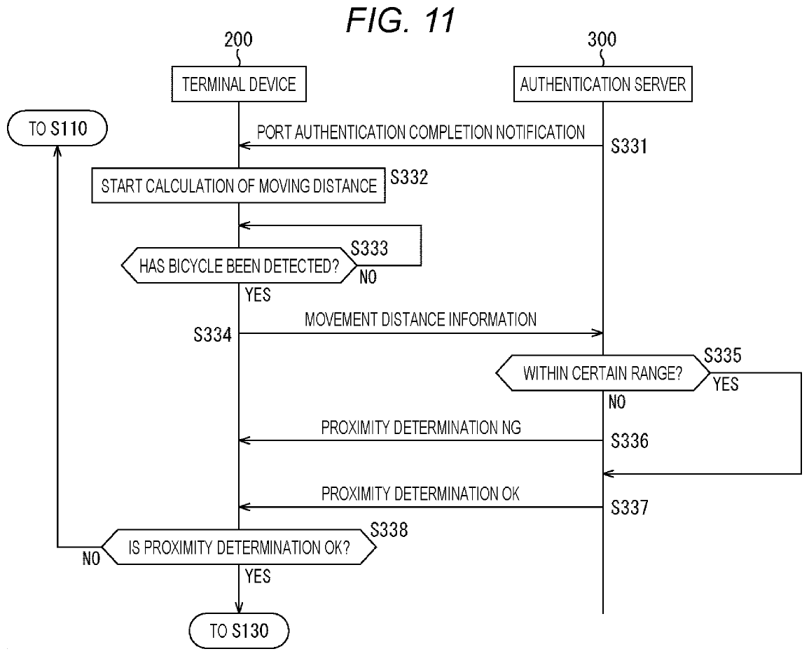

FIG. 11 is a diagram illustrating a second specific example of proximity determination processing of the non-mobile device 110 and the mobile device 120.

In the second specific example, as the determination information, moving distance information indicating a moving distance of the user (terminal device 200) acquired from the time related to the proximity operation with the port to the time related to the proximity operation with the bicycle is generated by the terminal device 200 and transmitted to the authentication server 300.

First, in step S331, as a result of the proximity operation with the non-mobile device 110, the authentication server 300 (communication unit 310) transmits a port authentication completion notification indicating that the authentication of the non-mobile device 110 (port) is completed to the terminal device 200.

In step S332, the terminal device 200 (determination information generation unit 254) starts calculation of the moving distance of the user (terminal device 200) from the time when the port authentication completion notification from the authentication server 300 is received. The moving distance of the terminal device 200 is calculated using a pedestrian dead reckoning (PDR) technique that performs relative positioning from a certain reference point on the basis of data from a plurality of autonomously operating sensors (an acceleration sensor, a gyro sensor, a magnetic sensor, an air pressure sensor, and the like), for example.

In step S333, the terminal device 200 (near field communication control unit 252) determines whether or not a bicycle has been detected by near field communication accompanying a proximity operation with the mobile device 120 (bicycle).

Step S333 is repeated until it is determined that the bicycle has been detected. When it is determined that the bicycle is detected, the determination information generation unit 254 stops the calculation of the moving distance, and the process proceeds to step S334.

In step S334, the terminal device 200 (communication unit 240) transmits, to the authentication server 300, moving distance information indicating a moving distance of the terminal device 200 acquired during the period from the time when the port authentication completion notification from the authentication server 300 is received to the time when the ACK response is received from the mobile device 120, as determination information.

In step S335, the authentication server 300 (proximity determination unit 331) determines whether or not the moving distance indicated by the moving distance information from the terminal device 200 is within a certain range with the port as a reference point, thereby determining the proximity state between the non-mobile device 110 and the mobile device 120.

In a case where it is determined that the moving distance indicated by the moving distance information is not within the certain range, in step S336, the authentication server 300 (communication unit 310) transmits a notification that proximity determination is NG to the terminal device 200.

On the other hand, in a case where it is determined that the moving distance indicated by the moving distance information is within the certain range, in step S337, the authentication server 300 (communication unit 310) transmits a notification indicating that the proximity determination is OK to the terminal device 200.

In step S338, the terminal device 200 (control unit 250) determines whether or not the proximity determination is OK on the basis of the notification received from the authentication server 300.

When it is determined that the proximity determination is not OK, that is, the proximity determination is NG, the process returns to step S110 (authentication processing of the non-mobile device 110). That is, the user again performs the proximity operation between the terminal device 200 and the non-mobile device 110 (port).

On the other hand, when it is determined that the proximity determination is OK, the proximity determination processing of the non-mobile device 110 and the mobile device 120 ends, and the process proceeds to step S130 (authentication processing of the mobile device 120).

In this way, it is grasped that the bicycle exists near the port on the basis of the moving distance of the user (terminal device 200) from the time related to the proximity operation with the port to the time related to the proximity operation with the bicycle.

### Third Specific Example

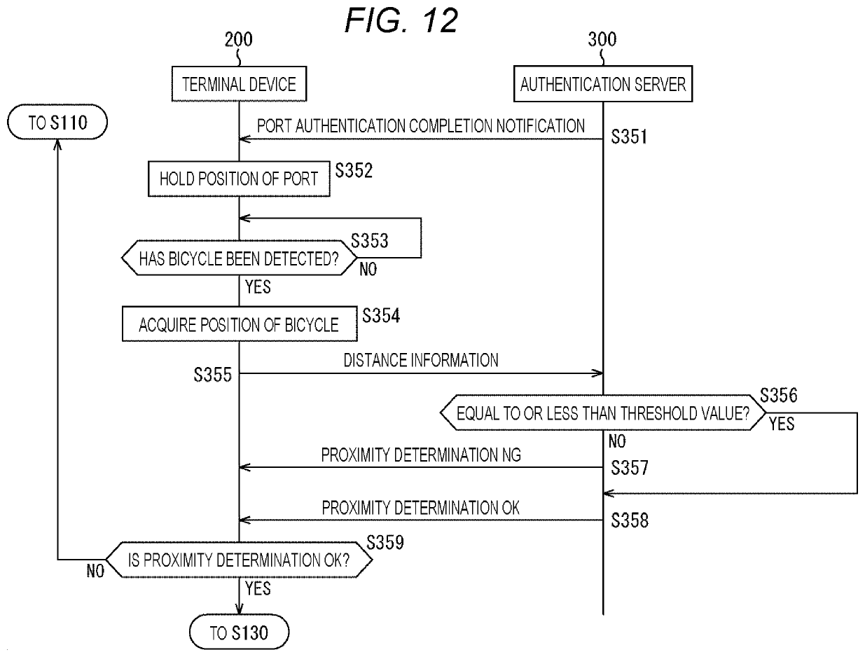

FIG. 12 is a diagram illustrating a third specific example of proximity determination processing of the non-mobile device 110 and the mobile device 120.

In the third specific example, distance information indicating a distance between the position of the port acquired in response to the proximity operation and the position of the bicycle acquired in response to the proximity operation is generated by the terminal device 200 and transmitted to the authentication server 300 as the determination information.

First, in step S351, as a result of the proximity operation with the non-mobile device 110, the authentication server 300 (communication unit 310) transmits a port authentication completion notification indicating that the authentication of the non-mobile device 110 (port) is completed to the terminal device 200.

In step S352, the terminal device 200 (determination information generation unit 254) holds the position (GPS information) of the port acquired in response to the proximity operation with the non-mobile device 110.

In step S353, the terminal device 200 (near field communication control unit 252) determines whether or not a bicycle has been detected by near field communication accompanying a proximity operation with the mobile device 120 (bicycle).

Step S353 is repeated until it is determined that the bicycle has been detected. When it is determined that the bicycle has been detected, the process proceeds to step S354.

In step S354, the terminal device 200 (determination information generation unit 254) acquires the GPS information of the terminal device 200 acquired when receiving the ACK response from the mobile device 120 as the position of the bicycle.

In step S355, the terminal device 200 (communication unit 240) transmits distance information indicating the distance between the position of the port acquired in response to the proximity operation with the non-mobile device 110 and the position of the bicycle at the time of receiving the ACK response from the mobile device 120 to the authentication server 300 as the determination information.

In step S356, the authentication server 300 (proximity determination unit 331) determines whether or not the distance indicated by the distance information from the terminal device 200 is equal to or less than a predetermined threshold value, thereby determining the proximity state between the non-mobile device 110 and the mobile device 120.

In a case where it is determined that the distance indicated by the distance information is not equal to or less than the threshold value, in step S357, the authentication server 300 (communication unit 310) transmits a notification that proximity determination is NG to the terminal device 200.

On the other hand, in a case where it is determined that the distance indicated by the distance information is equal to or less than the threshold value, in step S358, the authentication server 300 (communication unit 310) transmits a notification indicating that the proximity determination is OK to the terminal device 200.

In step S359, the terminal device 200 (control unit 250) determines whether or not the proximity determination is OK on the basis of the notification received from the authentication server 300.

When it is determined that the proximity determination is not OK, that is, the proximity determination is NG, the process returns to step S110 (authentication processing of the non-mobile device 110). That is, the user again performs the proximity operation between the terminal device 200 and the non-mobile device 110 (port).

On the other hand, when it is determined that the proximity determination is OK, the proximity determination processing of the non-mobile device 110 and the mobile device 120 ends, and the process proceeds to step S130 (authentication processing with the mobile device 120).

In this manner, it is grasped that the bicycle is present near the port on the basis of the distance between the position of the port acquired in response to the proximity operation and the position of the bicycle acquired in response to the proximity operation.

### Fourth Specific Example

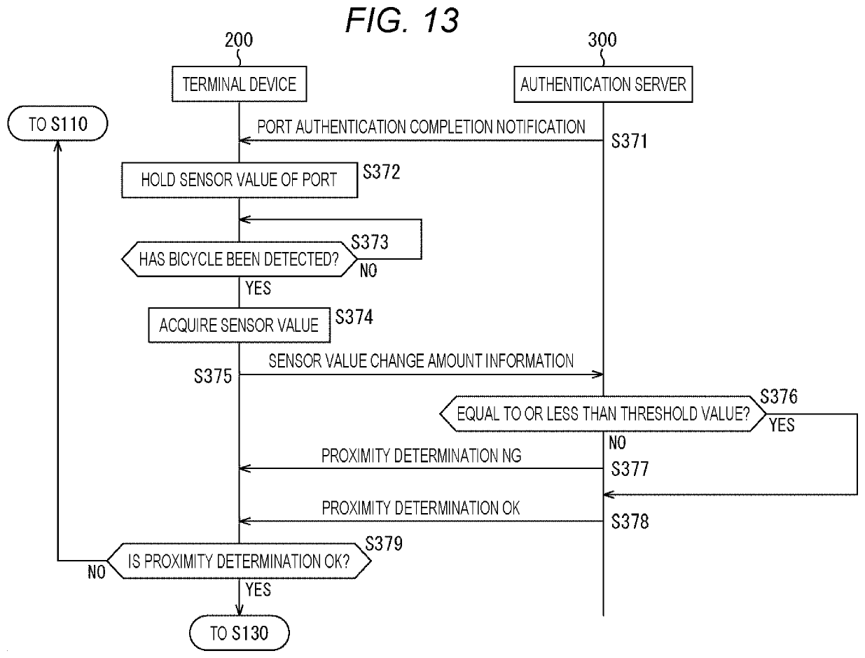

FIG. 13 is a diagram illustrating a fourth specific example of the proximity determination processing of the non-mobile device 110 and the mobile device 120.

In the fourth specific example, as the determination information, sensor value change amount information indicating a change amount of a sensor value between the position of the port acquired in response to the proximity operation and the position of the bicycle acquired in response to the proximity operation is generated by the terminal device 200 and transmitted to the authentication server 300.

First, in step S371, as a result of the proximity operation with the non-mobile device 110, the authentication server 300 (communication unit 310) transmits a port authentication completion notification indicating that the authentication of the non-mobile device 110 (port) is completed to the terminal device 200.

In step S372, the terminal device 200 (determination information generation unit 254) holds the sensor value (air pressure, temperature, acceleration, strength of magnetic field, and the like) at the position of the port acquired in response to the proximity operation with the non-mobile device 110. This sensor value is a sensor value acquired by the sensor value acquisition unit 114 of the non-mobile device 110.

In step S373, the terminal device 200 (near field communication control unit 252) determines whether or not a bicycle has been detected by near field communication accompanying a proximity operation with the mobile device 120 (bicycle).

Step S373 is repeated until it is determined that the bicycle has been detected. When it is determined that the bicycle has been detected, the process proceeds to step S374.

In step S374, the terminal device 200 (determination information generation unit 254) acquires the sensor value acquired by each sensor of the terminal device 200 when receiving the ACK response from the mobile device 120.

In step S375, the terminal device 200 (communication unit 240) transmits the sensor value change amount information indicating the change amount between the sensor value at the position of the port acquired in response to the proximity operation with the non-mobile device 110 and the sensor value at the position of the bicycle when the ACK response is received from the mobile device 120 to the authentication server 300 as the determination information.

In step S356, the authentication server 300 (proximity determination unit 331) determines whether or not the sensor value change amount indicated by the sensor value change amount information from the terminal device 200 is equal to or less than a predetermined threshold value, thereby determining the proximity state between the non-mobile device 110 and the mobile device 120.

In a case where it is determined that the sensor value change amount indicated by the sensor value change amount information is not equal to or less than the threshold value, in step S377, the authentication server 300 (communication unit 310) transmits a notification that the proximity determination is NG to the terminal device 200.

On the other hand, in a case where it is determined that the sensor value change amount indicated by the sensor value change amount information is equal to or less than the threshold value, in step S378, the authentication server 300 (communication unit 310) transmits a notification indicating that the proximity determination is OK to the terminal device 200.

In step S379, the terminal device 200 (control unit 250) determines whether or not the proximity determination is OK on the basis of the notification received from the authentication server 300.

When it is determined that the proximity determination is not OK, that is, the proximity determination is NG, the process returns to step S110 (authentication processing of the non-mobile device 110). That is, the user again performs the proximity operation between the terminal device 200 and the non-mobile device 110 (port).

On the other hand, when it is determined that the proximity determination is OK, the proximity determination processing of the non-mobile device 110 and the mobile device 120 ends, and the process proceeds to step S130 (authentication processing of the mobile device 120).

In this manner, it is grasped that the bicycle is present near the port on the basis of the change amount in the sensor value between the position of the port acquired in response to the proximity operation and the position of the bicycle acquired in response to the proximity operation, that is, the degree of change in the environment between the port and the bicycle. Note that, in the processing of FIG. 13, for example, GPS information may be acquired as the sensor values at respective positions of the port and the bicycle instead of the atmospheric pressure, the temperature, the acceleration, the strength of the magnetic field, and the like. In this case, from the terminal device 200, as the determination information, GPS information at respective positions of the port and the bicycle is transmitted to the authentication server 300 instead of the sensor value change amount information. In the authentication server 300, the proximity state between the non-mobile device 110 and the mobile device 120 is determined on the basis of these sensor values (GPS information) themselves instead of the sensor value change amount.

By the above processing, it is possible to determine the proximity state between the port and the bicycle by using the determination information generated on the basis of the physical quantity acquired in response to the proximity operation with the battery-less port and the physical quantity acquired in response to the proximity operation with the battery-less bicycle.

That is, it is not necessary for the port to include a battery for transmitting position information or for the bicycle to be equipped with a battery for communication and authentication with the authentication server, and it is possible to implement a system for grasping that a moving article (bicycle) exists in a specific area (port) at low cost.

In addition, it is possible to improve the business management of the business operator who provides the service using the share cycle system. Moreover, in local tourist cities that are severe in terms of budget, profitability, and the like, it is possible to spread services using the share cycle system.

Note that, as the proximity determination processing, two or more processes may be executed in parallel in addition to any one of the four processes described above. Furthermore, the terminal device 200 may transmit, to the authentication server 300, physical quantities such as a time and a position and a change amount of a sensor value acquired in response to a proximity operation with a port or a proximity operation with a bicycle, and the authentication server 300 may generate the determination information on the basis of the physical quantities from the terminal device 200. Furthermore, these proximity determination processes may be executed by the authentication server 300 as described above, or may be executed by the terminal device 200 as described later.

### <6. Details of Authentication Processing Between Non-Mobile Device and Mobile Device>

Hereinafter, details of the authentication processing (step S110) of the non-mobile device 110 (port) and the authentication processing (step S130) of the mobile device 120 (bicycle) in the overall flow of the operation of the authentication system of FIGS. 5 and 6 will be described. Note that the following processing is processing executed when the bicycle is rent.

### (Details of Authentication Processing of Non-Mobile Device)

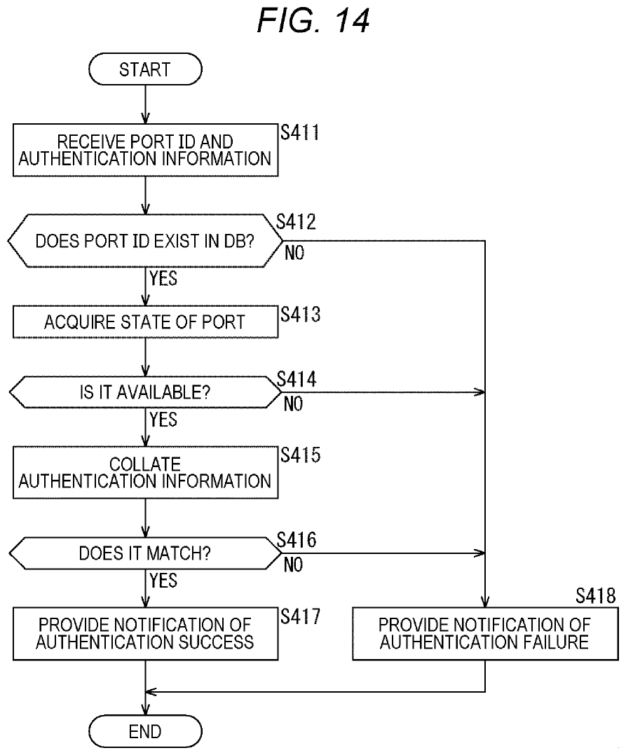

First, details of the authentication processing of the non-mobile device (port) executed by the authentication server 300 will be described with reference to a flowchart of FIG. 14. The processing of FIG. 14 is started when a proximity operation between the terminal device 200 and the non-mobile device 110 is performed. Note that the processing of FIG. 14 is executed before the proximity state between the non-mobile device 110 and the mobile device 120 is determined.

In step S411, the communication unit 310 receives the port ID (identification information of the non-mobile device 110) and the authentication information from the terminal device 200.

In step S412, the non-mobile device authentication unit 321 searches the non-mobile device management DB 340 for the port ID received from the terminal device 200 to determine whether or not the port ID exists in the non-mobile device management DB 340. In a case where it is determined that the port ID exists in the non-mobile device management DB 340, the process proceeds to step S413.

In step S413, the non-mobile device authentication unit 321 acquires the state of the port corresponding to the port ID (availability of the port) from the non-mobile device management DB 340.

In step S414, the non-mobile device authentication unit 321 determines whether or not the acquired state of the port is “available”. In a case where it is determined that the state of the port is “available”, the process proceeds to step S415.

In step S415, the non-mobile device authentication unit 321 collates the authentication information (MAC) received from the terminal device 200 with the authentication information (MAC) calculated by the non-mobile device authentication unit 321.

In step S416, the non-mobile device authentication unit 321 determines whether or not the authentication information received from the terminal device 200 matches the authentication information calculated by the non-mobile device authentication unit 321. In a case where it is determined that the authentication information matches, the process proceeds to step S417.

In step S417, the communication unit 310 notifies the terminal device 200 that the authentication of the non-mobile device 110 (port) is successful. In this way, in a case where the authentication of the port is successful, the proximity determination processing (step S120) of the non-mobile device 110 and the mobile device 120 is performed.

On the other hand, in a case where it is determined in step S412 that the port ID does not exist in the non-mobile device management DB 340, in a case where it is determined in step S414 that the state of the port is not “available”, and in a case where it is determined in step S416 that the authentication information does not match, the process proceeds to step S418.

In step S418, the communication unit 310 notifies the terminal device 200 that the authentication of the non-mobile device 110 (port) has failed. In this way, in a case where the authentication of the port fails, the proximity determination processing (step S120) of the non-mobile device 110 and the mobile device 120 is not performed.

In the processing described above, the authentication information of the non-mobile device 110 may include the sensor value acquired by the non-mobile device 110 or the terminal device 200 at the time of the proximity operation between the terminal device 200 and the non-mobile device 110. The sensor value is information indicating at least one of an environment in which the non-mobile device 110 exists or a state of the non-mobile device 110.

In this case, the non-mobile device authentication unit 321 can determine whether or not to perform authentication of the non-mobile device 110 on the basis of the sensor value included in the authentication information of the non-mobile device 110.

For example, in a case where the authentication information of the non-mobile device 110 includes position information acquired by a GPS sensor, if the position indicated by the position information is included in a predetermined area, the non-mobile device 110 is authenticated.

In a case where the authentication information of the non-mobile device 110 includes the atmospheric pressure acquired by the atmospheric pressure sensor, the non-mobile device 110 may be authenticated if the atmospheric pressure is an atmospheric pressure at a predetermined altitude of a specific mountain or highland, or the like.

In a case where the authentication information of the non-mobile device 110 includes the temperature acquired by the temperature sensor, the non-mobile device 110 may be authenticated if the temperature is a low temperature of a freezing chamber or the like.

In a case where the authentication information of the non-mobile device 110 includes the acceleration acquired by the acceleration sensor included in the terminal device 200, if the acceleration indicates that the terminal device 200 is substantially in a stopped state, the non-mobile device 110 may be authenticated.

In a case where the authentication information of the non-mobile device 110 includes the strength of the magnetic field acquired by the magnetic sensor, the non-mobile device 110 may be authenticated if the strength of the magnetic field does not exceed a certain strength.

### (Details of Authentication Processing of Mobile Device)

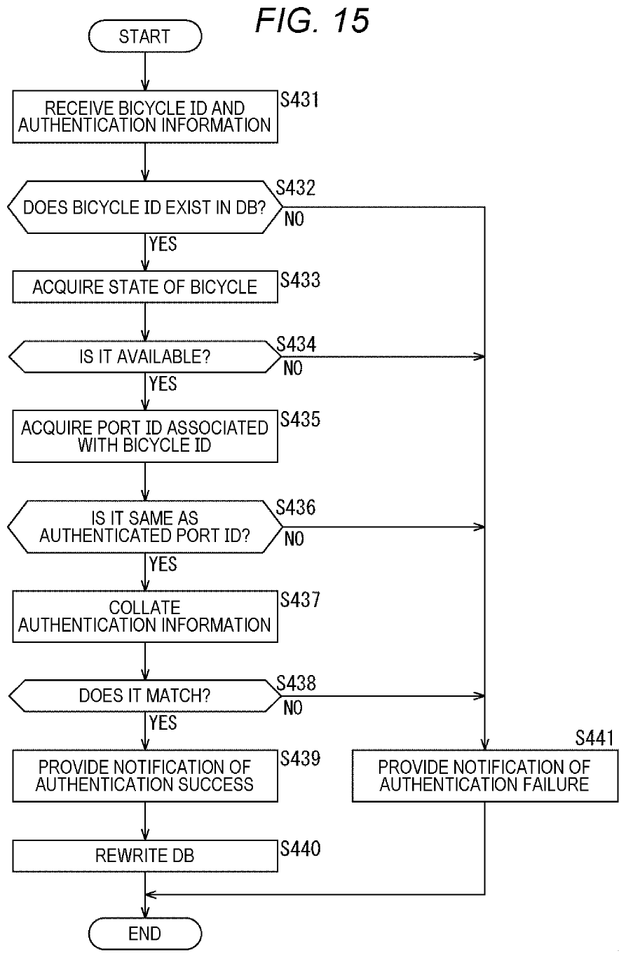

Next, details of authentication processing of the mobile device 120 (bicycle) executed by the authentication server 300 will be described with reference to a flowchart of FIG. 15. The processing of FIG. 15 is started when a proximity operation between the terminal device 200 and the mobile device 120 (bicycle) is performed and it is determined that the non-mobile device 110 and the mobile device 120 are in proximity.

In step S431, the communication unit 310 receives the bicycle ID (identification information of the mobile device 120) and the authentication information from the terminal device 200.

In step S432, the mobile device authentication unit 322 determines whether or not the bicycle ID exists in the mobile device management DB 350 by searching the mobile device management DB 350 for the bicycle ID received from the terminal device 200. In a case where it is determined that the bicycle ID exists in the mobile device management DB 350, the process proceeds to step S433.

In step S433, the mobile device authentication unit 322 acquires the state (rental state) of the bicycle corresponding to the bicycle ID from the mobile device management DB 350.

In step S434, the mobile device authentication unit 322 determines whether or not the acquired state of the bicycle is “available”. In a case where it is determined that the state of the bicycle is “available”, the process proceeds to step S435.

In step S435, the mobile device authentication unit 322 acquires the port ID associated with the bicycle ID (corresponding to the bicycle ID) from the mobile device management DB 350.

In step S436, the mobile device authentication unit 322 determines whether or not the acquired port ID is the same as the authenticated (successfully authenticated) port ID. In a case where it is determined that the acquired port ID is the same as the authenticated port ID, the process proceeds to step S437.

In step S437, the mobile device authentication unit 322 collates the authentication information (MAC) received from the terminal device 200 with the authentication information (MAC) calculated by the mobile device authentication unit 322. At this time, the authentication information (MAC) transmitted by the authentication server is also collated with the authentication information (MAC) calculated by the mobile device 120 in the mobile device 120.

In step S438, the mobile device authentication unit 322 determines whether or not the authentication information received from the terminal device 200 matches the authentication information calculated by the mobile device authentication unit 322. In the mobile device 120, it is also determined whether or not the authentication information transmitted by the authentication server 300 matches the authentication information calculated by the mobile device 120. In a case where it is determined that these pieces of authentication information match, the process proceeds to step S439.

In step S439, the communication unit 310 notifies the terminal device 200 that the authentication of the mobile device 120 (bicycle) is successful.

Moreover, in step S440, the mobile device authentication unit 322 rewrites the mobile device management DB 350.

For example, it is assumed that a user with a user ID “ZZZZZZ005” has rented the bicycle with the bicycle ID “YYYYY002” in the bicycle DB from the port with the port ID “XXXXXAAA” in the port DB in FIG. 4. In the example of FIG. 4, 10 bicycles are parked in the port with the port ID “XXXXXAAA”, and the state of the bicycle with the bicycle ID “YYYYY002” parked in the port is available.

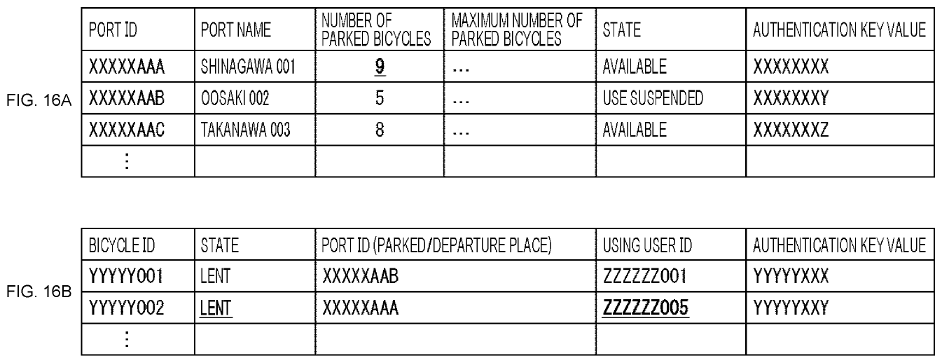

In a case where the bicycle with the bicycle ID “YYYYY002” is lent, as illustrated in A of FIG. 16, in the port DB, the “number of parked bicycles” of the port with the port ID “XXXXXAAA” is rewritten from “10” to “9”. Furthermore, as illustrated in B of FIG. 16, in the bicycle DB, the “state” of the bicycle with the bicycle ID “YYYYY002” is rewritten from “available” to “lent”, and the “using user ID” is rewritten from “none” to “ZZZZZZ005”.

In this way, in a case where the authentication of the bicycle is successful, locking/unlocking of the lock mechanism 126 is performed. In the above-described example, since the bicycle is lent out, the lock mechanism 126 is unlocked.

On the other hand, in a case where it is determined in step S432 that the bicycle ID does not exist in the mobile device management DB 350, in a case where it is determined in step S434 that the state of the bicycle is not “available”, in a case where it is determined in step S436 that the port ID is not the same as the authenticated port ID, and in a case where it is determined in step S438 that the authentication information does not match, the process proceeds to step S441.

In step S441, the communication unit 310 notifies the terminal device 200 that the authentication of the mobile device 120 (bicycle) has failed. In this way, in a case where the authentication of the bicycle fails, the locking/unlocking of the lock mechanism 126 is not performed.

As described above, the authentication of the port and the bicycle is performed in response to the proximity operation, so that a more secure share cycle system can be implemented.

### <7. Modifications and Other Application Examples>

Hereinafter, modifications and other application examples of an authentication system to which the technology of the present disclosure is applied will be described.

### (Modifications)

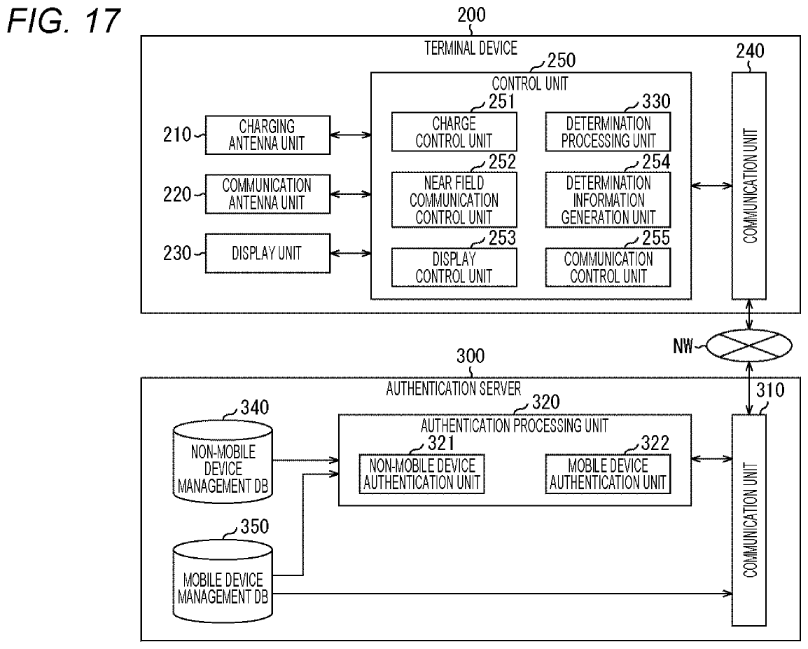

FIG. 17 is a block diagram illustrating another functional configuration example of the authentication system to which the technology according to the present disclosure is applied.

In FIG. 17, illustration of the non-mobile device 110 and the mobile device 120 is omitted. In the authentication system of FIG. 17, components similar to those of the authentication system of FIG. 3 are denoted by the same reference numerals, and the description thereof will be omitted.

That is, the authentication system of FIG. 17 is different from the authentication system of FIG. 3 in that the determination processing unit 330 is provided in the terminal device 200 instead of the authentication server 300.

With such a configuration, the terminal device 200 can determine the proximity state between the non-mobile device 110 and the mobile device 120 by executing the proximity determination processing using the determination information generated by the terminal device 200 itself.

### (Other Application Examples)

In the above-described embodiment, an example in which the technology according to the present disclosure is applied to a share cycle system has been described, but the technology according to the present disclosure can also be applied to other use cases.

(1) Case where Unlocking is Possible Only at a specific place

For example, the mobile device of the technology according to the present disclosure can be applied to an item that cannot be used unless the participant arrives at a specific place in an experience-based game in which the participant becomes a protagonist in reality, clears a riddle or a mission, or challenges by using physical strength.

### (2) Case of Confirming Arrival of Article at a Specific Place

In a case where hardware assets such as PCs are moved due to office transfer, stocktaking, or the like, it is possible to confirm whether or not each of the hardware assets is moved to a target location by applying the mobile device of the technology according to the present disclosure to the hardware assets.

(3) Case where Unlocking is Possible in a Place where Safety is Ensured

The mobile device of the technology according to the present disclosure can be applied to a firearm case that is not unlocked unless it is in a predetermined place such as a shooting range in an organization such as a police department that handles firearms such as handguns.

Furthermore, the mobile device of the technology according to the present disclosure can be applied to a document case that is not opened unless it is in a school building or an office building in a school or a government office that handles documents including personal information.

Moreover, the mobile device of the technology according to the present disclosure can also be applied to a delivery container that cannot be opened unless it is at a correct delivery destination.

(4) Case where Unlocking is Possible in a Specific Environment of a Specific Location

In the fields of agriculture, fishery, medical care, and the like, the mobile device of the technology according to the present disclosure can be applied to a food case or a medicine case that cannot be opened unless it is under a specific temperature such as a cryopreservation room, a vaccine case for carrying a vaccine against a specific viral infection, and the like.

In addition to the use cases described above, the technology according to the present disclosure can be applied to a system that enables locking/unlocking of an electronic lock of a mobile device only in a case where an article moving together with a user is present in a specific area.

Furthermore, as described above, the non-mobile device can be mounted on a mobile body that is movable and is used in a state of being stopped at a predetermined position.

### (5) Case of Grasping the Position of Cargo or the Like in the Field of Logistics

The mobile device of the technology according to the present disclosure can be applied to a system in which a driver of a truck can grasp that there is a load near a stopped truck at a certain time. In this case, the non-mobile device is mounted on the movable truck, and the mobile device is mounted on the cargo.

Furthermore, the mobile device of the technology according to the present disclosure can be applied to a system in which an employee of a cargo ship can grasp that a container unloaded from a cargo ship at a port is near the cargo ship at a certain time. In this case, the non-mobile device is mounted on the movable cargo ship, and the mobile device is mounted on the container.

Moreover, the mobile device of the technology according to the present disclosure can be applied to a system in which an employee of a port can grasp that a package taken out of a container is near the container at a certain time. In this case, the non-mobile device is mounted on the movable container, and the mobile device is mounted on the cargo.

### <8. Configuration Example of Computer>

A series of the processing described above can be executed by hardware, or may be executed by software. In a case where the series of processes is executed by software, a program constituting the software is installed from a program recording medium to a computer incorporated in dedicated hardware, a general-purpose personal computer, or the like.

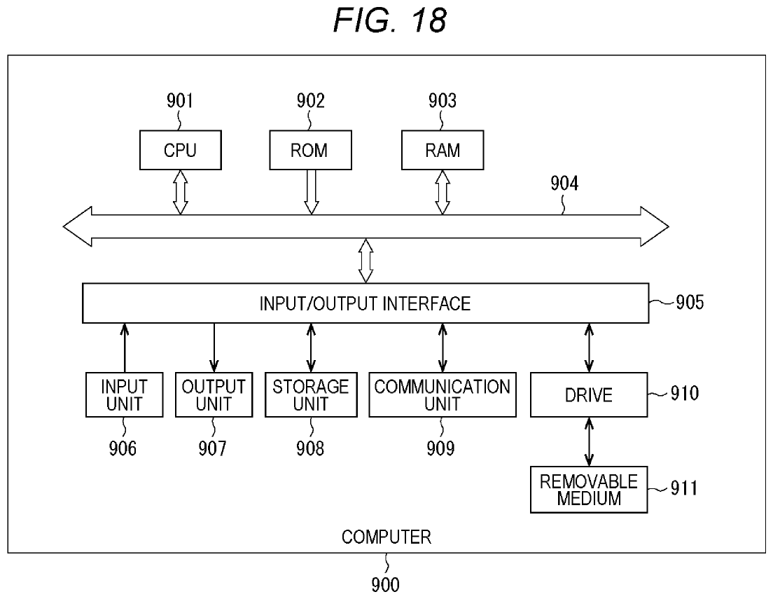

FIG. 18 is a block diagram illustrating a configuration example of hardware of a computer that executes the series of processes described above in accordance with a program.

The terminal device 200 and the authentication server 300 as information processing devices to which the technology according to the present disclosure can be applied are implemented by a computer 900 having a configuration illustrated in FIG. 18.

In the computer 900, a central processing unit (CPU) 901, a read only memory (ROM) 902, and a random access memory (RAM) 903 are mutually connected by a bus 904.

An input/output interface 905 is further connected to the bus 904. An input unit 906, an output unit 907, a storage unit 908, a communication unit 909, and a drive 910 are connected to the input/output interface 905.

The input unit 906 includes a keyboard, a mouse, a microphone, and the like. The output unit 907 includes a display, a speaker, and the like. The storage unit 908 includes a hard disk, a non-volatile memory and the like. The communication unit 909 includes a network interface and the like. The drive 910 drives a removable medium 911 such as a magnetic disk, an optical disk, a magneto-optical disk, or a semiconductor memory.

In the computer 900 configured as described above, for example, the CPU 901 loads a program stored in the storage unit 908 into the RAM 903 via the input/output interface 905 and the bus 904 and executes the program, whereby the above-described series of processing is performed.

The program executed by the computer 900 (CPU 901) can be provided by being recorded in the removable medium 911 as a package medium and the like, for example. Furthermore, the program can be provided via a wired or wireless transmission medium such as a local area network, the Internet, or digital satellite broadcasting.

In the computer 900, the program can be installed in the storage unit 908 via the input/output interface 905 by attaching the removable medium 911 to the drive 910. Also, the program may be received by the communication unit 909 by means of the wired or wireless transmission medium to be installed on the storage unit 908. In addition, the program may be installed in advance on the ROM 902 and the storage unit 908.

Note that the program executed by the computer 900 may be a program in which processing is performed in time series in the order described in the present specification, or may be a program in which processing is performed in parallel or at necessary timing such as when a call is made.

In the present specification, a step of describing a program recorded in a recording medium includes not only processing performed in chronological order according to the described order, but also processing executed in parallel or individually even if the processing is not necessarily performed in chronological order.

The embodiments of the technology according to the present disclosure are not limited to the above-described embodiments, and various modifications can be made without departing from the scope of the technology according to the present disclosure.

For example, the technology according to the present disclosure can have a configuration of cloud computing in which one function is shared and processed in cooperation by a plurality of devices via a network.

Furthermore, each step described in the above-described flowchart may be executed by one device or executed by a plurality of devices in a shared manner.

Moreover, in a case where a plurality of processing is included in one step, the plurality of processing included in one step can be executed by one device or by a plurality of devices in a shared manner.

The effects described in the present description are merely examples and are not limited, and other effects may be provided.

Moreover, the technology according to the present disclosure can have the following configurations.

(1)

An information processing device, including:
a proximity determination unit that determines a proximity state between a battery-less non-mobile device and a battery-less mobile device by using determination information generated on the basis of a first proximity operation with the non-mobile device and a second proximity operation with the mobile device.
   (2)

The information processing device according to (1), in which
the determination information includes a time from a time related to the first proximity operation with the non-mobile device to a time related to the second proximity operation with the mobile device.
   (3)

The information processing device according to (1), in which the determination information includes a moving distance of a user acquired from a time related to the first proximity operation with the non-mobile device to a time related to the second proximity operation with the mobile device.

(4)

The information processing device according to (1), in which
the determination information includes a distance between a position of the non-mobile device acquired according to the first proximity operation and a position of the mobile device acquired according to the second proximity operation.
   (5)

The information processing device according to (1), in which
the determination information includes a change amount of a sensor value between a position of the non-mobile device acquired according to the first proximity operation and a position of the mobile device acquired according to the second proximity operation.
   (6)

The information processing device according to any one of (1) to (5), in which
the determination information is generated on the basis of a first physical quantity acquired by a terminal device in response to the first proximity operation with the non-mobile device and a second physical quantity acquired by the terminal device in response to the second proximity operation with the mobile device.
   (7)

The information processing device according to any one of (1) to (5), further including:
a determination information generation unit that generates the determination information on the basis of a first physical quantity acquired in response to the first proximity operation with the non-mobile device and a second physical quantity acquired in response to the second proximity operation with the mobile device.
   (8)

The information processing device according to any one of (1) to (6), further including:
a state determination unit that determines whether or not an electronic lock of the mobile device is locked or unlocked on the basis of a determination result of a proximity state between the non-mobile device and the mobile device.
   (9)

The information processing device according to (8), further including:
a mobile device authentication unit that performs authentication of the mobile device on the basis of mobile device authentication information acquired in response to the second proximity operation in a case where it is determined that the non-mobile device and the mobile device are in proximity.
   (10)

The information processing device according to (9), in which
the mobile device authentication unit performs bidirectional authentication with the mobile device.
   (11)

The information processing device according to (9) or (10), in which
the mobile device authentication information includes a state of the electronic lock, and
the mobile device authentication unit authenticates the mobile device on the basis of a state of the electronic lock.
   (12)

The information processing device according to (11), in which
the mobile device authentication information further includes a state of a capacitor of the mobile device, and the mobile device authentication unit authenticates the mobile device on the basis of a charge amount of the capacitor.
   (13)

The information processing device according to (12), in which
the capacitor is charged by the second proximity operation.
   (14)

The information processing device according to any one of (8) to (13), further including:
a non-mobile device authentication unit that performs authentication of the non-mobile device on the basis of non-mobile device authentication information acquired in response to the first proximity operation before a proximity state between the non-mobile device and the mobile device is determined.
   (15)

The information processing device according to (14), in which
the non-mobile device authentication unit performs unidirectional authentication of the non-mobile device.
   (16)

The information processing device according to (14) or (15), in which
the proximity determination unit determines a proximity state between the non-mobile device and the mobile device in a case where authentication of the non-mobile device is successful.
   (17)

The information processing device according to any one of (14) to (16), in which
the non-mobile device authentication information includes a sensor value acquired by the non-mobile device, and
the non-mobile device authentication unit determines whether or not to perform authentication of the non-mobile device on the basis of the sensor value.
   (18)

The information processing device according to (17), in which
the sensor value indicates at least one of an environment in which the non-mobile device exists or a state of the non-mobile device.
   (19)

An information processing method, including:
by an information processing device,
determining a proximity state between a battery-less non-mobile device and a battery-less mobile device by using determination information generated on the basis of a first proximity operation with the non-mobile device and a second proximity operation with the mobile device.
   (20)

A program for causing a computer to execute:
processing of determining a proximity state between a battery-less non-mobile device and a battery-less mobile device by using determination information generated on the basis of a first proximity operation with the non-mobile device and a second proximity operation with the mobile device.

### REFERENCE SIGNS LIST

200 Terminal device
210 Charging antenna unit
220 Communication antenna unit
230 Display unit
240 Communication unit
250 Control unit
251 Charge control unit
252 Near field communication control unit
253 Display control unit
254 Determination information generation unit
255 Communication control unit
300 Authentication server
310 Communication unit
320 Authentication processing unit
321 Non-mobile device authentication unit
322 Mobile device authentication unit
330 Determination processing unit
331 Proximity determination unit
332 State determination unit
340 Non-mobile device management DB
350 Mobile device management DB
900 Computer
901 CPU

1. An information processing device, comprising:
a proximity determination unit that determines a proximity state between a battery-less non-mobile device and a battery-less mobile device by using determination information generated on a basis of a first proximity operation with the non-mobile device and a second proximity operation with the mobile device.

2. The information processing device according to claim 1, wherein
the determination information includes a time from a time related to the first proximity operation with the non-mobile device to a time related to the second proximity operation with the mobile device.

3. The information processing device according to claim 1, wherein the determination information includes a moving distance of a user acquired from a time related to the first proximity operation with the non-mobile device to a time related to the second proximity operation with the mobile device.

4. The information processing device according to claim 1, wherein
the determination information includes a distance between a position of the non-mobile device acquired according to the first proximity operation and a position of the mobile device acquired according to the second proximity operation.

5. The information processing device according to claim 1, wherein
the determination information includes a change amount of a sensor value between a position of the non-mobile device acquired according to the first proximity operation and a position of the mobile device acquired according to the second proximity operation.

6. The information processing device according to claim 1, wherein
the determination information is generated on a basis of a first physical quantity acquired by a terminal device in response to the first proximity operation with the non-mobile device and a second physical quantity acquired by the terminal device in response to the second proximity operation with the mobile device.

7. The information processing device according to claim 1, further comprising:
a determination information generation unit that generates the determination information on a basis of a first physical quantity acquired in response to the first proximity operation with the non-mobile device and a second physical quantity acquired in response to the second proximity operation with the mobile device.

8. The information processing device according to claim 1, further comprising:
a state determination unit that determines whether or not an electronic lock of the mobile device is locked or unlocked on a basis of a determination result of a proximity state between the non-mobile device and the mobile device.

9. The information processing device according to claim 8, further comprising:
a mobile device authentication unit that performs authentication of the mobile device on a basis of mobile device authentication information acquired in response to the second proximity operation in a case where it is determined that the non-mobile device and the mobile device are in proximity.

10. The information processing device according to claim 9, wherein
the mobile device authentication unit performs bidirectional authentication with the mobile device.

11. The information processing device according to claim 9, wherein
the mobile device authentication information includes a state of the electronic lock, and
the mobile device authentication unit authenticates the mobile device on a basis of a state of the electronic lock.

12. The information processing device according to claim 11, wherein
the mobile device authentication information further includes a state of a capacitor of the mobile device, and the mobile device authentication unit authenticates the mobile device on a basis of a charge amount of the capacitor.

13. The information processing device according to claim 12, wherein
the capacitor is charged by the second proximity operation.

14. The information processing device according to claim 8, further comprising:
a non-mobile device authentication unit that performs authentication of the non-mobile device on a basis of non-mobile device authentication information acquired in response to the first proximity operation before a proximity state between the non-mobile device and the mobile device is determined.

15. The information processing device according to claim 14, wherein
the non-mobile device authentication unit performs unidirectional authentication of the non-mobile device.

16. The information processing device according to claim 14, wherein
the proximity determination unit determines a proximity state between the non-mobile device and the mobile device in a case where authentication of the non-mobile device is successful.

17. The information processing device according to claim 14, wherein
the non-mobile device authentication information includes a sensor value acquired by the non-mobile device, and
the non-mobile device authentication unit determines whether or not to perform authentication of the non-mobile device on a basis of the sensor value.

18. The information processing device according to claim 17, wherein
the sensor value indicates at least one of an environment in which the non-mobile device exists or a state of the non-mobile device.

19. An information processing method, comprising:
by an information processing device,
determining a proximity state between a battery-less non-mobile device and a battery-less mobile device by using determination information generated on a basis of a first proximity operation with the non-mobile device and a second proximity operation with the mobile device.

20. A program for causing a computer to execute:
processing of determining a proximity state between a battery-less non-mobile device and a battery-less mobile device by using determination information generated on a basis of a first proximity operation with the non-mobile device and a second proximity operation with the mobile device.
